(19) United States
(12) Patent Application Publication
(10) Pub. No.: US 2026/0216682 A1
(43) Pub. Date: Jul. 30, 2026

(54) HOLLOW PARTICLES, ELASTOMER COMPOSITION AND ELASTOMER CROSSLINKED MOLDED BODY

(71) Applicant: ZEON CORPORATION, Tokyo (JP)

(72) Inventor: Arinobu Katada, Tokyo (JP)

(73) Assignee: ZEON CORPORATION, Tokyo (JP)

(21) Appl. No.: 19/149,167

(22) PCT Filed: Jan. 11, 2024
(86) PCT No.: PCT/JP2024/000391

§ 371 Date: Jul. 18, 2025

(30) Foreign Application Priority Data
Jan. 31, 2023 (JP) 2023-012416

(51) Int. Cl. B01J 13/18; B01J 13/20; C08F 212/36; C08F 222/10; C08L 23/16

(52) U.S. Cl. CPC B01J 13/185; B01J 13/206; C08F 212/36; C08F 222/102; C08F 222/103; C08L 23/16; C08L 2205/20; C08L 2312/00

(57) ABSTRACT

To provide hollow particles configured to reduce the weight of elastomer crosslinked molded bodies and the compression set thereof, an elastomer composition comprising the hollow particles, and a crosslinked molded body thereof. Hollow particles comprising a shell, which contains a resin, and a hollow portion surrounded by the shell, wherein the hollow particles have an iodine value of 10 g/100 g or more and 50 g/100 g or less, which is measured in accordance with JIS K 0070, and an elastomer composition comprising the hollow particles and a base material elastomer.

### TECHNICAL FIELD

The present disclosure relates to hollow particles, an elastomer composition comprising the hollow particles, and a crosslinked molded body thereof.

### BACKGROUND ART

Focusing on the rubber elasticity or flexibility of elastomer materials as typified by rubber, elastomer products are used in a wide range of fields for various kinds of applications such as a shock absorber, a fluid barrier gasket and a tube. In general, depending on the intended use, necessary components are mixed with a base material elastomer to obtain an elastomer composition; the elastomer composition is kneaded in a molten state; the base material elastomer is crosslinked while it is molded by a method such as extrusion molding or compression molding, thereby obtaining elastomer products in different forms, such as a part, a coating film and a tipping material for filling.

As a method for reducing the weight of elastomer products, it is known to mix a base material elastomer with a foaming agent and foam the mixed base material elastomer by heating in a molding step to obtain a foamed elastomer molded body. Patent Document 1 discloses the use of a rubber composition for vulcanization molding as a means to achieve the object of providing a rubber composition for vulcanization molding, which can be manufactured into a rubber product having good dimensional stability, good appearance and effectively light weight, and the rubber composition for vulcanization molding comprises a mixture of hollow particles and a base rubber, wherein the hollow particles comprise a thermoplastic resin shell and a thermally vaporizable blowing agent encapsulated therein and have a further expansion ratio ranging from 20% to 80%, and the base rubber has a specific Mooney viscosity at 100° C.

As a technical objective, the method of Patent Document 1 is directed at obtaining a foamed elastomer molded body having good dimensional stability. However, the method for producing the foamed elastomer molded body by mixing the base material elastomer with the foaming agent, has difficulty in controlling the size of pores formed by foaming and has limitations in achievable dimensional stability. Accordingly, a further improvement in dimensional stability is required in the production of elastomer molded bodies.

Meanwhile, as a method for imparting characteristics or functions such as weight reduction, heat insulation and opacification by introducing many fine pores in a molded body, it is known to use a molding material comprising a matrix resin and hollow particles contained therein (Patent Documents 2 and 3). In the molding material comprising the matrix resin and the hollow particles contained therein, the voids of the hollow particles contained in the molding material function as pores. Accordingly, unlike the case of using a foaming agent, there is no problem of controlling the size of pores formed by foaming.

### CITATION LIST

### Patent Documents

Patent Document 1: Japanese Patent No. 6116787
Patent Document 2: International Publication No. WO2020/261926
Patent Document 3: International Publication No. WO2021/112110

### SUMMARY

### Technical Problem

Also, elastomer products are required to have a small compression set. However, conventional elastomer products formed of a base material elastomer and hollow particles contained therein, are not products with an improved compression set.

In light of the above problems, an object of the present disclosure is to provide hollow particles configured to reduce the weight of elastomer crosslinked molded bodies and the compression set thereof.

Also, the present disclosure is to provide an elastomer composition comprising the hollow particles and a crosslinked molded body thereof.

### Solution to Problem

According to the present disclosure, there are provided hollow particles comprising a shell, which contains a resin, and a hollow portion surrounded by the shell, wherein the hollow particles have an iodine value of 10 g/100 g or more and 50 g/100 g or less, which is measured in accordance with JIS K 0070.

According to the present disclosure, there is also provided an elastomer composition comprising the hollow particles of the present disclosure and a base material elastomer.

According to the present disclosure, there is also provided an elastomer crosslinked molded body obtained by crosslinking molding the elastomer composition of the present disclosure.

### Advantageous Effects of Invention

By using the hollow particles of the present disclosure as a filler in an elastomer crosslinked molded body, the weight of the elastomer crosslinked molded body can be reduced, and the compression set thereof can be reduced.

Also, according to the present disclosure, a light-weight elastomer crosslinked molded body having a reduced compression set and an elastomer composition configured to be used as a molding material thereof, are provided.

### BRIEF DESCRIPTION OF DRAWING

FIG. 1 is a diagram illustrating an example of the method for producing the hollow particles of the present disclosure.

### DESCRIPTION OF EMBODIMENTS

Hereinafter, the hollow particles of the present disclosure, the method for producing the hollow particles of the present disclosure, the elastomer resin composition of the present disclosure, and the elastomer crosslinked molded body of the present disclosure will be described in detail.

In the present disclosure, “to” which shows a numerical range is used to describe a range in which the numerical values described before and after “to” indicate the lower limit value and the upper limit value.

### 1. Hollow Particles

The hollow particles of the present disclosure are hollow particles comprising a shell, which contains a resin, and a hollow portion surrounded by the shell, wherein the hollow particles have an iodine value of 10 g/100 g or more and 50 g/100 g or less, which is measured in accordance with JIS K 0070.

In the present disclosure, the iodine value measured in accordance with JIS K 0070, may be simply referred to as “iodine value”.

The iodine value of the hollow particles can be used as the index of the amount of reactive unsaturated bonds present on the outer surface of the hollow particles. Since the hollow particles of the present disclosure have an iodine value of 10 g/100 g or more, they have a specific amount or more of reactive unsaturated bonds on the outer surface. When an elastomer crosslinked molded body is obtained by mixing such hollow particles of the present disclosure with a base material elastomer, kneading the mixture and hot-pressing the kneaded mixture, at least at the time of hot-pressing, the reactive unsaturated bond on the outer surface of the hollow particles react with the reactive unsaturated bond of the base material elastomer to form a covalent bond. Accordingly, in the elastomer crosslinked molded body containing the hollow particles of the present disclosure, since the outer surface of the hollow particles is cross-linked to the base material elastomer, the interface of the hollow particles and that of the base material elastomer have excellent adhesion, and the interface of the hollow particles and that of the base material elastomer are less likely to be peeled off from each other. In addition, when external force is applied, the hollow particles show high restoring force and are less likely to cause plastic deformation compared to the base material elastomer. The reason why the compression set of the elastomer crosslinked molded body containing the hollow particles of the present disclosure is reduced, is estimated as follows: since the base material elastomer is cross-linked to the hollow particles, the base material elastomer follows the restoration of the hollow particles when external force is applied. It is thought that when, in the elastomer crosslinked molded body containing the hollow particles, the base material elastomer is not cross-linked to the outer surface of the hollow particles, plastic deformation of the base material elastomer is not suppressed, and the compression set increases, accordingly.

Also in the elastomer crosslinked molded body containing the hollow particles of the present disclosure, the hollow particles are less likely to collapse and are likely to retain the hollows. Accordingly, an excellent weight reduction effect is exerted by the hollow particles. The reason why the hollow particles of the present disclosure are less likely to collapse in the elastomer crosslinked molded body containing them, is estimated that a three-dimensional crosslinked structure is formed in the vicinity of the surface of the hollow particles after a reaction between the reactive unsaturated bonds on the surface of the hollow particles and the reactive unsaturated bonds of the base material elastomer. It is thought that due to the three-dimensional crosslinked structure, the Young's modulus of the elastomer crosslinked molded body containing the hollow particles of the present disclosure is increased, allowing for a reduction in compression set and an improvement in abrasion resistance.

When the iodine value of the hollow particles of the present disclosure is 10 g/100 g or more, sufficient amounts of crosslinks are formed between the hollow particles and the base material elastomer, and an excellent effect of reducing the compression set of the molded body is obtained, accordingly. The iodine value of the hollow particles of the present disclosure is preferably 12 g/100 g or more, more preferably 15 g/100 g or more, still more preferably 20 g/100 g or more, and even more preferably 30 g/100 g or more.

Meanwhile, when the iodine value of the hollow particles of the present disclosure is more than 50 g/100 g, there are too many reaction sites on the outer surface of the hollow particles, and the hollow particles are likely to be crosslinked to each other. Accordingly, the hollow particles are likely to aggregate; the dispersibility of the hollow particles deteriorates; and the compression set of the molded body cannot be sufficiently reduced. From the viewpoint of reducing the compression set of the molded body, the iodine value of the hollow particles of the present disclosure is preferably 45 g/100 g or less, and more preferably 40 g/100 g or less.

The hollow particles of the present disclosure comprise the shell (outer shell) which contains the resin and the hollow portion surrounded by the shell; moreover, they have the reactive unsaturated bonds on the outer surface of the shell.

As the reactive unsaturated bonds, examples include, but are not limited to, reactive unsaturated bonds contained in a vinyl group, a (meth)acryloyl group, an allyl group, a butenyl group, a maleimide group, a nadimide group, a propargyl group, an ethynyl group or the like. The reactive unsaturated bonds are preferably ethylenically unsaturated bonds, more preferably ethylenically unsaturated bonds contained in at least one selected from the group consisting vinyl group, a (meth)acryloyl group and an allyl group, and still more preferably ethylenically unsaturated bonds contained in at least one selected from the group consisting of a vinyl group and a (meth)acryloyl group.

In the hollow particles of the present disclosure, the reactive unsaturated bond on the outer surface of the shell may be the reactive unsaturated bond contained in the crosslinkable monomer unit or may be a reactive unsaturated bond contained in a coupling agent used for surface treatment. It is preferably the reactive unsaturated bond contained in the crosslinkable monomer unit. That is, at least one polymerizable functional group of the crosslinkable monomer, which remains unreacted, is preferably present on the shell surface.

The crosslinkable monomer, coupling agent and so on used in the production of the hollow particles of the present disclosure, will be described in detail in “2. Method for producing the hollow particles”.

The resin contained in the shell of the hollow particles of the present disclosure, is typically the polymer of a polymerizable monomer used in the hollow particle production method described below. The shell of the hollow particles may further contain a surface treatment agent, an additive and so on, to the extent that does not impair the objects of the present disclosure. The content of the resin contained in the shell of the hollow particles of the present disclosure, is preferably 80% by mass or more, more preferably 908 by mass or more, still more preferably 95% by mass or more and even more preferably 98% by mass or more. The shell may be composed of the resin.

The shell of the hollow particles of the present disclosure may be such that the outer surface of a resin layer containing the polymer of the polymerizable monomer, is surface-treated with a coupling agent. The shell of the hollow particles of the present disclosure is preferably surface-treated, since the mechanical properties of the elastomer crosslinked molded body containing the hollow particles of the present disclosure, such as tensile strength, tensile stress, tearing strength and abrasion resistance, are improved.

In the hollow particles of the present disclosure, the hollow portion is a hollow space clearly distinguished from the shell. The shell of the hollow particles may have a porous structure. In this case, the hollow portion has a size that is clearly distinguishable from many minute spaces uniformly dispersed in the porous structure. From the viewpoint of mechanical strength and so on, the hollow particles of the present disclosure preferably have a solid shell.

From the viewpoint of weight reduction effect, the hollow portion of the hollow particles of the present disclosure is preferably filled with gas such as air.

The hollow particles of the present disclosure may have one hollow portion or two or more hollow portions. From the viewpoint of maintaining good balance between the high void ratio and the mechanical strength, the hollow particles preferably have only one or two hollow portions, and more preferably have only one hollow portion. In the hollow particles of the present disclosure, the percentage of the number of the particles having only one hollow portion is preferably 90% or more, more preferably 95% or more, and still more preferably more than 95%.

The shell of the hollow particles of the present disclosure and, when the hollow particles have two or more hollow portions, a partition separating the adjacent hollow portions from each other may be porous. From the viewpoint of reducing the compression set of the molded product, the shell and the partition are preferably solid.

The shape of the hollow particles of the present disclosure may be a spherical shape, an ellipsoidal shape or an irregular shape, for example. From the viewpoint of the dispersibility and pressure resistance of the hollow particles, the shape is preferably a spherical shape.

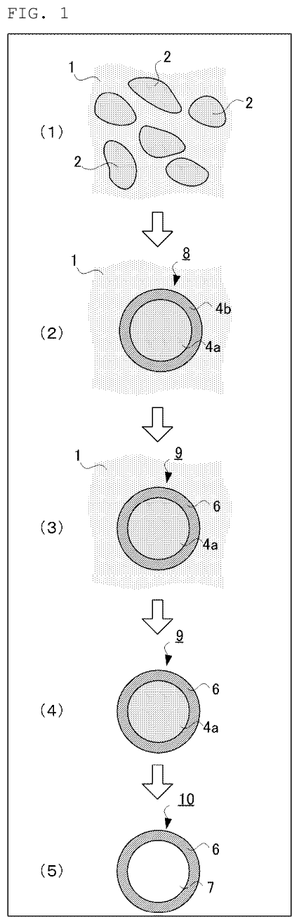

An exemplary image of the shape of the hollow particles of the present disclosure, is a bag which is made of a thin film and inflated with gas. A cross-section of the bag is like the hollow particle 10 shown in the diagram (5) of FIG. 1. In this example, one thin film is provided on the outside, and the interior is filled with gas.

The hollow portion of the hollow particles can be determined by, for example, SEM observation of a cross section of the particles or TEM observation of the particles as they are. The shape of the particles can be determined by SEM or TEM observation of the hollow particles, for example.

The hollow particles of the present disclosure may contain, as impurities, small amounts of particles having a low circularity, such as cracked or deformed particles. From the viewpoint of weight reduction effect and from the viewpoint of reducing the compression set of the molded product, in 100% by mass of the hollow particles, the percentage of the particles having a circularity of 0.85 or less is preferably less than 15% by mass, more preferably less than 10% by mass, and still more preferably less than 8% by mass.

The particles having a circularity of 0.85 or less are typically cracked particles or deformed particles such as dented particles. In the present disclosure, such particles may be referred to as “irregular-shaped particles”. Such irregular-shaped particles have a low void ratio compared to spherical hollow particles; therefore, they have poor weight reduction effect. Accordingly, the weight reduction effect of the hollow particles can be improved by decreasing the percentage of the irregular-shaped particles included in the hollow particles. Also, the irregular-shaped particles have the following problem: compared to spherical particles, the irregular-shaped particles are poor in dispersibility since they are likely to aggregate when dispersed in the base material elastomer. Therefore, the dispersibility of the hollow particles can be improved by decreasing the percentage of the irregular-shaped particles included in the hollow particles, and the compression set of the molded body can be further reduced, accordingly. In addition, the irregular-shaped particles have the following problem: they are poor in pressure resistance compared to spherical particles, since external pressure is likely to be locally applied thereto. When the irregular-shaped particles are dispersed in the base material elastomer, aggregates are likely to be formed; external pressure is likely to be applied to the aggregates; and the pressure resistance further deteriorates, accordingly. Therefore, the pressure resistance of the hollow particles can be improved by decreasing the percentage of the irregular-shaped particles included in the hollow particles.

The term “circularity” is defined as a value obtained by dividing the equivalent circular area diameter which is the diameter of a circle having the same area as the projected image of a particle, by the equivalent circular perimeter diameter which is the diameter of a circle having the same perimeter as the projected image of the particle. The circularity is 1 when the hollow particles are perfectly spherical, and it gets smaller as the surface shape of the hollow particles is more complex.

The average circularity of the hollow particles of the present disclosure may be from 0.950 to 0.995.

In the present disclosure, the circularity is measured by use of a flow particle image analyzer at an image resolution of 0.185 μm/pixel.

As the flow particle image analyzer, for example, IF-3200 (product name, manufactured by JASCO International Co., Ltd.) is preferably used. The measurement sample is prepared by, for example, performing a dispersion treatment of a mixture liquid, which is obtained by adding 0.10 g to 0.12 g of the hollow particles to an aqueous solution of linear alkylbenzene sulfonate (concentration 0.3%), in an ultrasonic cleaner for 5 minutes.

The average circularity is the average of the circularities of randomly selected 1000 to 3000 particles.

The void ratio of the hollow particles of the present disclosure is not particularly limited. From the viewpoint of weight reduction effect, it is preferably 60% or more, more preferably 65% or more, and still more preferably 70% or more. The upper limit of the void ratio of the hollow particles is not particularly limited. From the viewpoint of suppressing a decrease in the strength of the hollow particles and improving the collapse-resistance of the hollow particles, the void ratio is preferably 90% or less, more preferably 85% or less, and still more preferably 80% or less.

The void ratio of the hollow particles can be calculated from the apparent density D₁ and true density Do of the hollow particles.

A method for measuring the apparent density D₁ of the hollow particles is as follows. First, approximately 30 cm³ of the hollow particles are introduced into a measuring flask with a volume of 100 cm³, and the mass of the introduced hollow particles is precisely weighed. Next, the measuring flask in which the hollow particles are introduced, is precisely filled with isopropanol up to the marked line while care is taken so that air bubbles do not get in. The mass of the isopropanol added to the measuring flask is precisely weighed, and the apparent density D₁ (g/cm³) of the hollow particles is calculated by the following formula (I).

$$Apparent density {D}_{1} = [ Mass of the hollow particles ] / ( 100 - [ Mass of the isopropanol ] / [ Specific gravity of the isopropanol at the measuring temperature ] ) \qquad Formula ( I )$$

The apparent density D₁ is equivalent to the specific gravity of the whole hollow particle in the case where the hollow portion is regarded as a part of the hollow particle.

A method for measuring the true density Do of the hollow particles is as follows. The hollow particles are pulverized in advance; approximately 10 g of the pulverized hollow particles are introduced into a measuring flask with a volume of 100 cm³; and the mass of the introduced pulverized particles is precisely weighed. After that, similarly to the measurement of the apparent density mentioned above, isopropanol is added to the measuring flask; the mass of the isopropanol is precisely weighed; and the true density D₀ (g/cm³) of the hollow particles is calculated by the following formula (II).

$$True density {D}_{0} = [ Mass of the pulverized hollow particles ] / ( 100 - [ Mass of the ispropanol ] / [ Specific gravity of the isopropanol at the measuring temperature ] ) \qquad Formula ( II )$$

The true density Do is equivalent to the specific gravity of the shell portion alone of the hollow particle. As is clear from the measurement method mentioned above, when calculating the true density Do, the hollow portion is not regarded as a part of the hollow particle.

The void ratio (%) of the hollow particles is calculated by the following formula (III) from the apparent density D₁ and the true density D₀.

$$Void ratio ( \% ) = 100 - ( Apparent density {D}_{1} / True density {D}_{0} ) \times 100 \qquad Formula ( III )$$

The volume average particle diameter of the hollow particles of the present disclosure is not particularly limited. The volume average particle diameter of the hollow particles is preferably 0.1 μm or more, and more preferably 1 μm or more as the lower limit. On the other hand, it is preferably 100 μm or less, more preferably 80 μm or less, and still more preferably 50 μm or less as the upper limit. When the volume average particle diameter of the hollow particles of the present disclosure is equal to or more than the lower limit value, the aggregation of the hollow particles is suppressed, and the dispersibility thereof is improved. Accordingly, the effect of reducing the compression set of the molded body improves. When the volume average particle diameter of the hollow particles of the present disclosure is equal to or less than the upper limit value, a decrease in the specific surface area of the hollow particles is suppressed. As a result, a decrease in the interface of the hollow particles and that of the base material elastomer is suppressed; the amount of the crosslinks formed between the hollow particles and the base material elastomer is increased; and the effect of reducing the compression set of the molded body is improved, accordingly.

The particle size distribution (volume average particle diameter (Dv)/number average particle diameter (Dp)) of the hollow particles is not particularly limited. It is preferably 1.05 or more and 1.30 or less, and more preferably 1.10 or more and 1.30 or less. When the particle size distribution is 1.30 or less, the effect of reducing the compression set of the molded body tends to be excellent, and hollow particles such that performance slightly vary between the hollow particles, can be obtained. Also when the particle size distribution is 1.30 or less, the uniformity of the thickness of the product obtained by forming the elastomer crosslinked molded body into a sheet, can be improved.

The volume average particle diameter (Dv) and number average particle diameter (Dp) of the hollow particles can be found as follows, for example. The particle diameter of the hollow particles is measured with a particle size distribution measuring device by the Coulter counter method; the number average and volume average of the particle diameters are calculated; and the obtained values can be used as the number average particle diameter (Dp) and volume average particle diameter (Dv) of the hollow particles. The particle size distribution is found by dividing the volume average particle diameter by the number average particle diameter. The Coulter counter method is a method for measuring the diameter of particles by the electric resistance method called the Coulter Principle.

The residual volatile component content of the hollow particles of the present disclosure is not particularly limited, and it is preferably less than 100 ppm. When the residual volatile component content of the hollow particles is large, the residual volatile component is present on the outer surface of the hollow particles. The residual volatile component on the outer surface of the hollow particles interferes with the reaction between the reactive unsaturated bonds on the outer surface of the hollow particles and the reactive unsaturated bonds of the base material elastomer. Accordingly, when the residual volatile component content of the hollow particles is large, the adhesion between the hollow particles and base material elastomer contained in the elastomer crosslinked molded body deteriorates, resulting in an increase in the compression set of the molded body. On the other hand, when the residual volatile component content of the hollow particles is less than 100 ppm, an increase in the compression set of the molded body can be sufficiently suppressed. From the viewpoint of reducing the compression set of the molded body, the residual volatile component content of the hollow particles of the present disclosure is more preferably less than 50 ppm, and still more preferably less than 30 ppm.

In general, the residual volatile component is an organic compound having a molecular weight of 500 or less. As the residual volatile component, examples include, but are not limited to, a residual polymerizable monomer, a residual hydrophobic solvent, and a decomposition product of a polymerization initiator. Also, the residual volatile component content is the proportion of the mass of the residual volatile component contained in the hollow particles, with respect to the mass of the hollow particles.

The lower limit value of the residual volatile component content of the hollow particles of the present disclosure is not particularly limited. From the viewpoint of ease of production, it may be 1 ppm or more, may be 2 ppm or more, or may be 3 ppm or more, for example.

The residual volatile component content of the hollow particles can be measured by purge and trap gas chromatography (P&T/GC). In particular, the measurement method described below in “Examples” can be employed.

In the hollow particles of the present disclosure, the total content of a surfactant and a water-soluble polymer stabilizer which are present on the outer surface of the particles (hereinafter, they are simply referred to as “surfactant and so on”) is preferably 500 ppm or less, more preferably 200 ppm or less, still more preferably 100 ppm or less, and even more preferably 50 ppm or less. The water-soluble polymer stabilizer may be an organic or inorganic water-soluble polymer stabilizer. When the content of the surfactant and so on present on the outer surface of the hollow particles is equal to or less than the upper limit value, a decrease in the reactivity between the hollow particles and the base material elastomer is suppressed, and the effect of reducing the compression set of the molded body is improved. By using only an inorganic dispersion stabilizer in the hollow particles production process described below, the content of the surfactant and so on present on the surface of the hollow particles can be controlled to less than the measurement limit value.

In the present disclosure, the content of the surfactant and so on present on the outer surface of the hollow particles is the proportion of the mass of the surfactant and so on present on the outer surface of the hollow particles, with respect to the mass of the hollow particles. The surfactant and so on present on the outer surface of the hollow particles can be extracted by, for example, ultrasonic treatment of the hollow particles in water. The type and mass of the surfactant and so on extracted into water can be determined by the peak position and peak intensity of a 1H-NMR spectrum. In this method, the measurement limit of the amount of the surfactant and so on present on the surface of the hollow particles, is generally 0.05 ppm.

The thermal decomposition initiation temperature of the hollow particles of the present disclosure is not particularly limited. From the viewpoint of heat resistance, it is preferably 345° C. or more, and more preferably 350° C. or more. The upper limit of the thermal decomposition initiation temperature of the hollow particles is not particularly limited. For example, it may be 400° C. or less.

In the present disclosure, the thermal decomposition initiation temperature of the hollow particles can be measured as a 5% weight reduction temperature, using a TG-DTA device in a nitrogen atmosphere, in the condition of a nitrogen flow rate of 230 mL/min and a temperature increase rate of 10° C./min.

The hollow particles of the present disclosure are used as an additive in the elastomer composition, which is a molding material of the elastomer crosslinked molded body, for the purpose of reducing the weight of the elastomer crosslinked molded body and reducing the compression set thereof. In addition to the reduction of the weight and compression set of the elastomer crosslinked molded body, the hollow particles of the present disclosure can impart various properties to the elastomer crosslinked molded body, such as heat insulation and the retention of a functional component such as an antibacterial agent. The applications of the elastomer composition containing the hollow particles of the present disclosure and those of the crosslinked molded body thereof will be described in detail in “3. Elastomer composition”.

In addition, by adding the hollow particles of the present disclosure to a resin, a coating material, various kinds of molded bodies and so on, various properties such as weight reduction, heat dielectric insulation, reduction, sound insulation, vibration control and light scattering can be imparted to these materials. Accordingly, the hollow particles of the present disclosure can be used in the following, for example: materials such as a light reflective material, an antiglare film, a light diffusion material (e.g., a light diffusion film or plate), a heat insulation material, a sound insulation material and a low dielectric material, which are used in various kinds of fields such as the automotive field, the electronics field, the electric field, the architecture field, the aviation field and the space field, and food containers, footwears such as sports shoes and sandals, household appliance parts, bicycle parts, stationery supplies, tools, filaments of 3D printers, and floating buoyant materials such as syntactic foam. The hollow particles of the present disclosure have a high void ratio, are less likely to collapse, and have high heat resistance. Accordingly, the hollow particles have heat insulation properties and shock-absorbing properties (cushioning properties) required of an undercoating material, and they also have heat resistance in line with thermal paper uses. Further, the hollow particles of the present disclosure are useful as a plastic pigment that is excellent in gloss, hiding power, etc.

A useful component such as a perfume, a medicine, an agricultural chemical and an ink component can be enclosed in the interior of the hollow particles of the present disclosure by a means such as immersion treatment or depressurized or pressurized immersion treatment. Accordingly, the hollow particles in which such a useful component is enclosed, can be used for various applications in accordance with the component contained in the interior.

Also, the hollow particles of the present disclosure are suitable as a rust retardant. Since the hollow particles of the present disclosure are also useful as an additive for decreasing electric conductivity, for example, a coating material containing the hollow particles of the present disclosure can be used as a rust-resistant coating material (such as a coating primer and a lubricating coating material) for increasing the anticorrosivity and rust resistance of steel and so on. A rust-resistant additive may be included in the hollow particles added to rust-resistant coating materials.

### 2. Method for Producing the Hollow Particles

The hollow particles of the present disclosure are produced by, for example, the production method described below, which is based on the suspension polymerization method.

For Example, an Embodiment of the Method for Producing the Hollow Particles of the Present Disclosure is a Hollow Particle Production Method Comprising:
preparing a mixture liquid containing a polymerizable monomer, a hydrophobic solvent, a polymerization initiator, a dispersion stabilizer and an aqueous medium,
suspending the mixture liquid to prepare a suspension in which droplets of a monomer composition containing the polymerizable monomer, the hydrophobic solvent and the polymerization initiator are dispersed in the aqueous medium,
subjecting the suspension to a polymerization reaction to prepare a precursor composition in which precursor particles comprising a shell, which contains a resin, and a hollow portion surrounded by the shell and filled with the hydrophobic solvent, are dispersed in the aqueous medium, and
removing the hydrophobic solvent from the precursor particles.

In the present disclosure, the hollow particles having the hollow portion filled with the hydrophobic solvent, may be considered as the intermediate of the hollow particles in which the hollow portion is filled with gas, and they may be referred to as the “precursor particles”. Also in the present disclosure, the “precursor composition” means a composition containing the precursor particles.

In the production method, by suspending the mixture liquid containing the polymerizable monomer, the hydrophobic solvent, the polymerization initiator, the dispersion stabilizer and the aqueous medium, phase separation occurs between the polymerizable monomer and the hydrophobic solvent. Accordingly, the suspension in which the droplets of the monomer composition are dispersed in the aqueous medium is prepared, the droplets having a distribution structure such that the polymerizable monomer is distributed on the surface side and the hydrophobic solvent is distributed in the center. By subjecting the suspension to a polymerization reaction, a polymer starts to precipitate on the surface of the droplets of the monomer composition, and the polymerization reaction is further developed. Accordingly, the surface of the droplets is cured to form the shell, thereby obtaining the hollow particles having the hollow portion filled with the hydrophobic solvent.

The reactive unsaturated bonds can be introduced to the outer surface of the shell by incorporating the crosslinkable monomer in the mixture liquid.

The above-described production method includes the steps of preparing the mixture liquid, preparing the suspension, subjecting the suspension to a polymerization reaction, and removing the hydrophobic solvent from the precursor particles. The method may further include other steps. As far as technically possible, two or more of the above steps and other additional steps may be simultaneously carried out as one step, or their order may be changed and then they may be carried out in that order. For example, the preparation and suspension of the mixture liquid may be simultaneously carried out in one step (for example, the mixture liquid may be suspended while adding the materials for the mixture liquid).

A preferred embodiment of the method for producing the hollow particles may be a production method including the following steps.

### (1) Mixture Liquid Preparation Step

The mixture liquid preparation step includes preparing a mixture liquid containing a polymerizable monomer, a hydrophobic solvent, a polymerization initiator, a dispersion stabilizer and an aqueous medium.

### (2) Suspension Step

The suspension step includes suspending the mixture liquid to prepare a suspension in which droplets of a monomer composition containing the polymerizable monomer, the hydrophobic solvent and the polymerization initiator are dispersed in the aqueous medium.

### (3) Polymerization Step

The polymerization step includes subjecting the suspension to a polymerization reaction to prepare a precursor composition in which precursor particles comprising a shell, which contains a resin, and a hollow portion surrounded by the shell and filled with the hydrophobic solvent, are dispersed in the aqueous medium.

### (4) Solid-Liquid Separation Step

The solid-liquid separation step includes performing solid-liquid separation of the precursor composition to obtain a solid component containing the precursor particles.

### (5) Solvent Removal Step

The solvent removal step includes removing the hydrophobic solvent from the precursor particles obtained by the solid-liquid separation step to obtain the hollow particles.

FIG. 1 is a schematic diagram showing an example of the production method of the present disclosure. The diagrams (1) to (5) in FIG. 1 correspond to the steps (1) to (5) described above, respectively. White arrows between the diagrams indicate the order of the steps. FIG. 1 is merely a schematic diagram for description, and the production method of the present disclosure is not limited to the method shown in FIG. 1. Further, the structures, dimensions and shapes of materials used for the production method of the present disclosure are not limited to the structures, dimensions and shapes of various materials shown in these diagrams.

The diagram (1) of FIG. 1 is a schematic cross-sectional view showing an embodiment of the mixture liquid in the mixture liquid preparation step. As shown in the diagram, the mixture liquid contains an aqueous medium 1 and a low polarity material 2 dispersed in the aqueous medium 1. Here, the low polarity material 2 means a material that has low polarity and is less likely to mix with the aqueous medium 1. In the present disclosure, the low polarity material 2 contains the polymerizable monomer, the hydrophobic solvent and the polymerization initiator.

The diagram (2) of FIG. 1 is a schematic cross-sectional view showing an embodiment of the suspension in the suspension step. The suspension contains the aqueous medium 1 and droplets 8 of the monomer composition dispersed in the aqueous medium 1. The droplets 8 of the monomer composition contain the polymerizable monomer, the hydrophobic solvent and the polymerization initiator, and their distribution in the droplets is not uniform. The droplets 8 of the monomer composition have the following structure: phase separation occurs between a hydrophobic solvent 4a and a material 4b containing the polymerizable monomer and not containing the hydrophobic solvent; the hydrophobic solvent 4a is distributed in the center; the material 4b not containing the hydrophobic solvent is distributed on the surface side; and the dispersion stabilizer (not shown) is on the surface.

The diagram (3) of FIG. 1 is a schematic cross-sectional view showing an embodiment of the precursor composition obtained by the polymerization step, which contains the precursor particles which include the hydrophobic solvent in the hollow portion. The precursor composition contains the aqueous medium 1 and precursor particles 9 which include the hydrophobic solvent 4a in the hollow portion and which are dispersed in the aqueous medium 1. A shell 6 forming the outer surface of the precursor particles 9 is formed by polymerization of the polymerizable monomer contained in the droplets 8 of the monomer composition. The precursor particles 9 contain, as the resin, the polymer of the polymerizable monomer.

The diagram (4) of FIG. 1 is a schematic cross-sectional view showing an embodiment of the precursor particles after the solid-liquid separation step. The diagram (4) of FIG. 1 shows a state where the aqueous medium 1 has been removed from the state shown in the diagram (3) of FIG. 1.

The diagram (5) of FIG. 1 is a schematic cross-sectional view showing an embodiment of the hollow particles after the solvent removal step. The diagram (5) of FIG. 1 shows a state where the hydrophobic solvent 4a has been removed from the state shown in the diagram (4) of FIG. 1. By the removal of the hydrophobic solvent from the precursor particles, hollow particles 10 having a gas-filled hollow portion 7 in the interior of the shell 6, are obtained.

Hereinafter, the five steps described above and other steps are described in order.

### (1) Mixture Liquid Preparation Step

The mixture liquid preparation step includes preparing a mixture liquid containing a polymerizable monomer, a hydrophobic solvent, a polymerization initiator, a dispersion stabilizer and an aqueous medium. The mixture liquid may further contain other materials to the extent that does not impair the objects of the present disclosure.

The materials for the mixture liquid will be described in the following order: (A) the polymerizable monomer, (B) the hydrophobic solvent, (C) the polymerization initiator, (D) the dispersion stabilizer and (E) the aqueous medium.

### (A) Polymerizable Monomer

In the present disclosure, the polymerizable monomer is a compound containing an addition-polymerizable functional group (in the present disclosure, it may be simply referred to as “polymerizable functional group”). In the present disclosure, as the polymerizable monomer, a compound which contains an ethylenically unsaturated bond as the addition-polymerizable functional group, is generally used. The polymerizable functional group is preferably a radically polymerizable group. From the viewpoint of excellent reactivity, the polymerizable functional group is preferably at least one selected from the group consisting of a (meth)acryloyl group, a vinyl group and an allyl group, and more preferably at least one selected from the group consisting of a (meth)acryloyl group and a vinyl group.

In the present disclosure, a polymerizable monomer which has only one polymerizable functional group is referred to as a non-crosslinkable monomer, and a polymerizable monomer which has two or more polymerizable functional groups is referred to as a crosslinkable monomer. The crosslinkable monomer can form crosslinking in the polymer by polymerization reaction. The crosslinkable monomer becomes a crosslinkable monomer unit in the shell, and the non-crosslinkable monomer becomes a non-crosslinkable monomer unit in the shell.

Also in the present disclosure, a polymerizable monomer composed of the elements carbon and hydrogen is referred to as “hydrocarbon monomer”; a crosslinkable monomer composed of the elements carbon and hydrogen is referred to as “crosslinkable hydrocarbon monomer”; and a non-crosslinkable monomer composed of the elements carbon and hydrogen is referred to as “non-crosslinkable hydrocarbon monomer”. Also in the present disclosure, a polymerizable monomer containing a (meth)acryloyl group as a polymerizable functional group is referred to as “acrylic monomer”; a crosslinkable monomer containing a (meth)acryloyl group as a polymerizable functional group is referred to as “crosslinkable acrylic monomer”; and a non-crosslinkable monomer containing a (meth)acryloyl group as a polymerizable functional group is referred to as “non-crosslinkable acrylic monomer”. In the crosslinkable acrylic monomer, at least one polymerizable functional group is only required to be a (meth)acryloyl group, and all polymerizable functional groups are preferably (meth)acryloyl groups.

Also in the present disclosure, (meth)acrylate means each of acrylate and methacrylate; (meth)acryl means each of acryl and methacryl; and (meth)acryloyl means each of acryloyl and methacryloyl.

As the polymerizable monomer, a known polymerizable monomer that is conventionally used for the production of hollow polymer particles, can be used without particular limitation. From the viewpoint of controlling the iodine value of the hollow particles within the above range, the polymerizable monomer preferably contains at least a crosslinkable monomer. The iodine value of the hollow particles is estimated to be within the above range, since part of the reactive unsaturated bonds of the crosslinkable monomer remains unreacted on the outer surface of the shell.

When the crosslinkable monomer is contained as the polymerizable monomer, in the polymerization reaction of the suspension, the crosslinking density of the polymer precipitated on the surface of the droplets increases, and the precipitates are crosslinked. Accordingly, the crosslinking density of the shell can be increased. As a result, the shell excellent in strength is easily formed; the thus-obtained hollow particles tend to be spherical; and the hollow portion that is clearly distinguished from the shell is easily formed in the interior of the particles. As the shell strength improves, the hollow particles are less likely to cause plastic deformation. Accordingly, by improving the shell strength, the effect of reducing the compression set of the molded body can be improved.

As the crosslinkable monomer, examples include, but are not limited to, the following: a crosslinkable hydrocarbon monomer such as aromatic an divinyl monomer (e.g., divinylbenzene, divinylbiphenyl and divinylnaphthalene), a diene monomer (e.g., a linear or branched diolefin such as butadiene, isoprene, 2,3-dimethylbutadiene, pentadiene and hexadiene, and an alicyclic diolefin such as dicyclopentadiene, cyclopentadiene and ethylidene tetracyclododecene) and a crosslinkable macromer (e.g., a polybutadiene, a polyisoprene, a styrene-butadiene block copolymer (SBS) and a styrene-isoprene block copolymer (SIS)); a crosslinkable acrylic monomer such as a difunctional crosslinkable acrylic monomer (e.g., allyl (meth)acrylate, vinyl (meth)acrylate, ethylene glycol di(meth)acrylate, diethylene glycol di(meth)acrylate, pentaerythritol di(meth)acrylate, tricyclodecane dimethanol di(meth)acrylate, 3-(meth)acryloyloxy-2-hydroxypropyl (meth)acrylate, 1,3-bis(methacryloyloxy)-2-hydroxypropane, 1,6-hexanediol di(meth)acrylate, 1,9-nonanediol di(meth)acrylate, 1,10-decanediol di(meth)acrylate, neopentyl glycol di(meth)acrylate, polyethylene glycol di(meth)acrylate, polypropylene glycol di(meth)acrylate and bisphenol A di(meth)acrylate), a trifunctional or higher-functional crosslinkable acrylic monomer (e.g., trimethylolpropane tri(meth)acrylate, ditrimethylolpropane tetra(meth)acrylate, pentaerythritol tri(meth)acrylate, pentaerythritol tetra(meth)acrylate, dipentaerythritol hexa(meth)acrylate and dipentaerythritol poly(meth)acrylate), and ethoxylates thereof; a crosslinkable allyl monomer such as diallyl phthalate; and a crosslinkable macromer such as both-vinyl-terminated polyphenylene ether and both-(meth)acrylic-terminated polyphenylene ether. These crosslinkable monomers may be used alone or in combination of two or more.

In the present disclosure, from the viewpoint of controlling the iodine value of the hollow particles within the above range and from the viewpoint of reducing the compression set of the molded body by improving the shell strength, the crosslinkable monomer preferably contains at least one selected from the group consisting of the crosslinkable acrylic monomer and the crosslinkable hydrocarbon monomer; the crosslinkable monomer more preferably contains at least the crosslinkable acrylic monomer; and the crosslinkable monomer particularly preferably contains a combination of the crosslinkable acrylic monomer and the crosslinkable hydrocarbon monomer.

Among the crosslinkable monomers, the crosslinkable acrylic monomer is preferred from the viewpoint of improving the shell strength, while the crosslinkable hydrocarbon monomer is preferred since the reactive unsaturated bonds can be easily introduced to the outer surface of the shell.

Among crosslinkable hydrocarbon monomers, an aromatic divinyl monomer is preferred, and a divinylbenzene is particularly preferred.

As the crosslinkable acrylic monomer, any of the above-described difunctional crosslinkable acrylic monomer and the trifunctional or higher-functional crosslinkable acrylic monomer is preferred. From the viewpoint of improving the shell strength and reducing the compression set of the molded body, at least the difunctional crosslinkable acrylic monomer is preferably contained, and a combination of the difunctional crosslinkable acrylic monomer and the trifunctional or higher-functional crosslinkable acrylic monomer is more preferably contained. The difunctional crosslinkable acrylic monomer is preferably at least one selected from the group consisting of ethylene glycol di(meth)acrylate, diethylene glycol di(meth)acrylate and pentaerythritol di(meth)acrylate. The trifunctional or higher-functional crosslinkable acrylic monomer is preferably at least one selected from the group consisting of trimethylolpropane tri(meth)acrylate, ditrimethylolpropane tetra(meth)acrylate, pentaerythritol tri(meth)acrylate and pentaerythritol tetra(meth)acrylate.

In the present disclosure, from the viewpoint of controlling the iodine value of the hollow particles within the above range and from the viewpoint of reducing the compression set of the molded body by improving the shell strength, the content of the crosslinkable monomer in 100% by mass of the polymerizable monomer is preferably 50% by mass or more, more preferably 70% by mass or more, still more preferably 90% by mass or more, and even more preferably 95% by mass or more. In the present disclosure, the polymerizable monomer may be composed of the crosslinkable monomer, or a non-crosslinkable monomer described below may be further contained as the polymerizable monomer. Accordingly, the content of the crosslinkable monomer in 100% by mass of the polymerizable monomer may be 99% by mass or less, may be 98% by mass or less, or may be 97% by mass or less, for example.

The content of each monomer in 100% by mass of the polymerizable monomer, corresponds to the content of each monomer unit in 100% by mass of all monomer units constituting the polymer contained in the shell.

From the viewpoint of controlling the iodine value of the hollow particles within the above range and from the viewpoint of reducing the compression set of the molded body by improving the shell strength, the content of the crosslinkable hydrocarbon monomer in 100% by mass of the polymerizable monomer is preferably 10% by mass or more, more preferably 308 by mass or more, and still more preferably 40% by mass or more as the lower limit. On the other hand, the upper limit is not particularly limited and may be 100% by mass. The content is preferably 90% by mass or less, more preferably 80% by mass or less, still more preferably 70% by mass or less, even more preferably 60% by mass or less as the upper limit.

From the same viewpoint, the content of the crosslinkable acrylic monomer in 100% by mass of the polymerizable monomer is preferably 10% by mass or more, more preferably 20% by mass or more, still more preferably 30% by mass or more, and even more preferably 40% by mass or more as the lower limit. It is preferably 90% by mass or less, more preferably 70% by mass or less, and still more preferably 60% by mass or less as the upper limit.

When the combination of the difunctional crosslinkable acrylic monomer and the trifunctional or higher-functional crosslinkable acrylic monomer is contained, from the viewpoint of controlling the iodine value of the hollow particles within the above range and from the viewpoint of: reducing the compression set of the molded body by improving the shell strength, with respect to a total of 100% by mass of the difunctional crosslinkable acrylic monomer and the trifunctional or higher-functional crosslinkable acrylic monomer, the content of the difunctional crosslinkable acrylic monomer is preferably 20% by mass or more, more preferably 30% by mass or more, and still more preferably 40% by mass or more as the lower limit. On the other hand, it is preferably 70% by mass or less, more preferably 60% by mass or less, and still more preferably 50% by mass or less as the upper limit.

From the viewpoint of controlling the iodine value of the hollow particles within the above range and from the viewpoint of reducing the compression set of the molded body by improving the shell strength, when the crosslinkable monomer contains the crosslinkable acrylic monomer and the crosslinkable hydrocarbon monomer, with respect to a total of 100 parts by mass of the crosslinkable acrylic monomer and the crosslinkable hydrocarbon monomer, the content of the crosslinkable acrylic monomer is preferably 10 parts by mass or more, more preferably 20 parts by mass or more, still more preferably 30 parts by mass or more, and even more preferably 40 parts by mass or more as the lower limit. On the other hand, it is preferably 70 parts by mass or less, and more preferably 60 parts by mass or less as the upper limit.

In the present disclosure, from the viewpoint of controlling the iodine value of the hollow particles within the above range and from the viewpoint of reducing the compression set of the molded body by improving the shell strength, in 100 parts by mass of the crosslinkable monomer, the total content of the crosslinkable acrylic monomer and the crosslinkable hydrocarbon monomer is preferably 80 parts by mass or more, more preferably 90 parts by mass or more, still more preferably 95 parts by mass or more, and even more preferably 99 parts by mass or more.

In the present disclosure, a non-crosslinkable monomer may be further contained as the polymerizable monomer.

As the non-crosslinkable monomer, examples include, but are not limited to, the following: a non-crosslinkable hydrocarbon monomer such as an aromatic monovinyl monomer (e.g., styrene, vinyl toluene, α-methylstyrene, p-methylstyrene, ethylvinylbenzene, ethylvinylbiphenyl and ethylvinylnaphthalene), a linear or branched monoolefin (e.g., ethylene, propylene and butylene) and an alicyclic monoolefin (e.g., vinylcyclohexane, norbornene, tricyclododecene and 1,4-methano-1,4,4a, 9a-tetrahydrofluorene); a non-crosslinkable acrylic monomer such as methyl (meth)acrylate, ethyl (meth)acrylate, butyl (meth)acrylate, 2-ethylhexyl (meth)acrylate, lauryl (meth)acrylate), t-butylaminoethyl (meth)acrylate, glycidyl (meth)acrylate, 2-hydroxyethyl (meth)acrylate, 2-aminoethyl (meth)acrylate, (meth)acrylic acid, (meth)acrylamide, N-methylol (meth)acrylamide, N-butoxymethyl (meth)acrylamide, methoxypolyethylene glycol (meth)acrylate, ethoxypolyethylene glycol (meth)acrylate, propoxypolyethylene glycol (meth)acrylate, butoxypolyethylene glycol (meth)acrylate, hexaoxypolyethylene glycol (meth)acrylate, octoxypolyethylene glycol polypropylene glycol (meth)acrylate, lauroxypolyethylene e glycol (meth)acrylate, stearoxypolyethylene glycol (meth)acrylate, phenoxypolyethylene glycol polypropylene glycol (meth)acrylate, polyethylene glycol mono(meth)acrylate, polypropylene glycol mono(meth)acrylate, polyethylene glycol propylene glycol mono(meth)acrylate, polyethylene glycol tetramethylene glycol (meth)acrylate, propylene glycol polybutylene glycol mono(meth)acrylate, and monoethylene glycol mono(meth)acrylate; a carboxylic acid vinyl ester monomer such as vinyl acetate; a halogenated aromatic vinyl monomer such as halogenated styrene; a vinyl halide monomer such as vinyl chloride; a vinylidene halide monomer such as vinylidene chloride; a vinylpyridine monomer; and a non-crosslinkable macromer such as (meth)acrylic-terminated polystyrene and (meth)acrylic-terminated polymethyl methacrylate. These non-crosslinkable monomers may be used alone or in combination of two or more.

The content of the non-crosslinkable monomer in 100% by mass of the polymerizable monomer is preferably 50% by mass or less, more preferably 30% by mass or less, still more preferably 10% by mass or less, and even more preferably 5% by mass or less, from the viewpoint of controlling the iodine value of the hollow particles within the above range and from the viewpoint of suppressing a decrease in the shell strength. The lower limit of the content of the non-crosslinkable monomer in 100% by mass of the polymerizable monomer, is not particularly limited. For example, it may be 18 by mass or more, may be 2% by mass or more, or may be 3% by mass or more.

The content of the polymerizable monomer in the mixture liquid is not particularly limited. From the viewpoint of the balance of the void ratio, particle diameter and mechanical strength of the hollow particles, with respect to the total mass (100% by mass) of the components (except for the aqueous medium) in the mixture liquid, the content of the polymerizable monomer is preferably from 15% by mass to 50% by mass, and more preferably from 20% by mass to 40% by mass.

From the viewpoint of suppressing a decrease in the strength of the obtained hollow particles, the content of the polymerizable monomer is preferably 96% by mass or more, and more preferably 97% by mass or more, with respect to the total mass (100% by mass) of a solid content obtained by excluding the hydrophobic solvent from the material for the oil phase in the mixture liquid.

In the present disclosure, the solid content includes all components excluding solvent, and a liquid polymerizable monomer and the like are included in the solid content.

### (B) Hydrophobic Solvent

The hydrophobic solvent used in the production method of the present disclosure is a non-polymerizable, sparingly water-soluble organic solvent.

The hydrophobic solvent serves as a spacer material for forming the hollow portion in the interior of the particles. In the suspension step described later, the suspension in which the droplets of the monomer composition containing the hydrophobic solvent are dispersed in the aqueous medium, is obtained. In the suspension step, phase separation occurs in the droplets of the monomer composition. As a result, the hydrophobic solvent with low polarity is likely to collect in the interior of the droplets of the monomer composition. In the end, according to their respective polarities, the hydrophobic solvent is distributed in the interior of the droplets of the monomer composition, and the material not containing the hydrophobic solvent is distributed at the periphery of the droplets of the monomer composition.

Then, in the polymerization step described later, an aqueous dispersion containing the precursor particles including the hydrophobic solvent, is obtained. That is, since the hydrophobic solvent collects in the interior of the particles, the hollow portion filled with the hydrophobic solvent is formed in the interior of the obtained precursor particles.

The hydrophobic solvent can be appropriately selected from the group consisting of known hydrophobic solvents, without particular limitation. As the hydrophobic solvent, examples include, but are not limited to, an ester such as ethyl acetate and butyl acetate; an ether ester such as propylene glycol monomethyl ether acetate and propylene glycol monoethyl ether acetate; and a hydrocarbon solvent. Of them, a hydrocarbon solvent is preferred, and a hydrocarbon solvent containing 5 to 8 carbon atoms is more preferred.

As the hydrocarbon solvent, examples include, but are not limited to, an aromatic hydrocarbon solvent such as benzene, toluene and xylene, and aliphatic hydrocarbons including a chain hydrocarbon solvent such as pentane, hexane, heptane, octane, 2-methylbutane, 2-methylpentane and a paraffin-based solvent, and a cyclic hydrocarbon solvent such as cyclohexane, methylcyclohexane and cycloheptane.

These hydrophobic solvents may be used alone or in combination of two or more.

From the point of view that phase separation is likely to occur between the polymerizable monomer and hydrophobic solvent in the droplets of the monomer composition during the suspension step, such an organic solvent is preferably selected as the hydrophobic solvent, that the water solubility of the organic solvent is smaller than that of the crosslinkable monomer contained in the polymerizable monomer.

When the polymerizable monomer contains the hydrocarbon monomer in an amount of 30% by mass or more, the hydrophobic solvent is preferably a hydrocarbon solvent, more preferably a chain hydrocarbon solvent, still more preferably a chain hydrocarbon solvent containing 5 to 8 carbon atoms, and even more preferably at least one selected from the group consisting of pentane, hexane, heptane and octane.

The boiling point of the hydrophobic solvent is not particularly limited. From the viewpoint of ease of removal in the solvent removal step described later, the boiling point of the hydrophobic solvent is preferably 130° C. or less, and more preferably 100° C. or less. On the other hand, the boiling point of the hydrophobic solvent is preferably 50° C. or more, and more preferably 60° C. or more, from the point of view that the hydrophobic solvent can be easily included in the precursor particles.

When the hydrophobic solvent is a mixed solvent containing more than one kind of hydrophobic solvent and it has more than one boiling point, the boiling point of the solvent having the highest boiling point among the solvents contained in the mixed solvent, is preferably equal to or less than the upper limit value, and the boiling point of the solvent having the lowest boiling point among the solvents contained in the mixed solvent, is preferably equal to or more than the lower limit value.

The relative permittivity of the hydrophobic solvent at 20° C. is preferably 2.5 or less. The relative permittivity is one of the indices of the level of the polarity of a compound. In the case where the hydrophobic solvent has a sufficiently small relative permittivity of 2.5 or less, it is considered that phase separation progresses rapidly in the droplets of the monomer composition and the hollow portion can be easily formed.

Examples of hydrophobic solvents having a relative permittivity at 20° C. of 2.5 or less, are as follows. The inside of the parentheses is the value of relative permittivity.
Pentane (1.8), hexane (1.9), heptane (1.9), octane (1.9), cyclohexane (2.0)

For the relative permittivity at 20° C., values written in known literatures (for example, the Chemical Society of Japan, as editor, “Kagaku Binran, Kiso Hen, Kaitei 4 Ban”, pp. II-498 to II-503, published by Maruzen Publishing Co., Ltd. on Sep. 30, 1993) and other technical information may be used as reference. Examples of the method of measuring the relative permittivity at 20° C. include a relative permittivity test that is in conformity with 23 of JIS C 2101:1999 and is performed with the measuring temperature set to 20° C.

The void ratio of the hollow particles can be controlled by changing the amount of the hydrophobic solvent in the mixture liquid. In the suspension step described later, the polymerization reaction progresses while oil droplets containing the polymerizable monomer and so on include the hydrophobic solvent. Accordingly, as the content of the hydrophobic solvent increases, the void ratio of the obtained hollow particles tends to increase.

In the present disclosure, with respect to 100 parts by mass of the polymerizable monomer, the content of the hydrophobic solvent in the mixture liquid is preferably 100 parts by mass or more and 650 parts by mass or less, from the following viewpoints: the particle diameter of the hollow particles can be easily controlled; the void ratio can be easily increased while maintaining the strength of the hollow particles; and the amount of the residual hydrophobic solvent in the hollow particles can be easily decreased. The content of the hydrophobic solvent in the mixture liquid is more preferably 120 parts by mass or more and 500 parts by mass or less, and still more preferably 140 parts by mass or more and 300 parts by mass or less, with respect to 100 parts by mass of the polymerizable monomer.

### (C) Polymerization Initiator

In the production method of the present disclosure, the mixture liquid preferably contains an oil-soluble polymerization initiator as the polymerization initiator. The oil-soluble polymerization initiator is not particularly limited, as long as it is a lipophilic one having a solubility in water of 0.2% by mass or less. As the oil-soluble polymerization initiator, examples include, but are not limited to, an organic peroxide such as benzoyl peroxide, lauroyl peroxide, t-butyl peroxy-2-ethylhexanoate, t-butylperoxy diethylacetate and t-butylperoxy pivalate, and an azo compound such as 2,2′-azobis(2,4-dimethylvaleronitrile), azobis(isobutyronitrile) and 2,2′-azobis(4-methoxy-2,4-dimethylvaleronitrile).

With respect to 100 parts by mass of the polymerizable monomer in the mixture liquid, the content of the polymerization initiator is preferably from 0.1 parts by mass to 10 parts by mass, more preferably from 0.5 parts by mass to 7 parts by mass, and still more preferably from 1 part by mass to 5 parts by mass. When the content of the polymerization initiator is equal to or more than the lower limit value, a polymerization reaction can progress sufficiently. When the content of the polymerization initiator is equal to or less than the upper limit value, the polymerization initiator is less likely to remain after the end of the polymerization reaction, and an unexpected side reaction is less likely to progress.

### (D) Dispersion Stabilizer

The dispersion stabilizer is an agent for dispersing the droplets of the monomer composition in the aqueous medium in the suspension step. As the dispersion stabilizer, examples include, but are not limited to, an inorganic dispersion stabilizer, an organic or inorganic water-soluble polymer stabilizer and a surfactant.

n the present disclosure, an inorganic dispersion stabilizer is preferably used as the dispersion stabilizer, from the following viewpoints: the particle diameter of the droplets can be easily controlled in the suspension, and the dispersion stabilizer can be easily removed by the washing step; moreover, an excessive decrease in the shell thickness is suppressed, and a decrease in the strength of the hollow particles is suppressed.

As the inorganic dispersion stabilizer, examples include, but are not limited to, inorganic compounds including a sulfate such as barium sulfate and calcium sulfate; a carbonate such as barium carbonate, calcium carbonate and magnesium carbonate; a phosphate such as calcium phosphate; a metal oxide such as aluminum oxide and titanium oxide; a metal hydroxide such as aluminum hydroxide, magnesium hydroxide, calcium hydroxide, barium hydroxide and iron (II) hydroxide; and silicon dioxide. These inorganic dispersion stabilizers may be used alone or in combination of two or more.

As the inorganic dispersion stabilizer, a sparingly water-soluble inorganic dispersion stabilizer is preferably used. The term “sparingly water-soluble” is preferably such that the solubility in water at 25° C. is less than 1 g/L.

As the sparingly water-soluble inorganic dispersion stabilizer, a metal hydroxide is preferred, and a magnesium hydroxide is more preferred.

In the present disclosure, the sparingly water-soluble inorganic dispersion stabilizer is particularly preferably used in the form of colloidal particles being dispersed in the aqueous medium, that is, in the form of a colloidal dispersion containing the sparingly water-soluble, inorganic dispersion stabilizer colloidal particles. Accordingly, the inorganic dispersion stabilizer can be easily removed by the washing step described below.

The colloidal dispersion containing the sparingly water-soluble inorganic dispersion stabilizer colloidal particles can be prepared by, for example, reacting at least one selected from the group consisting of alkali metal hydroxide salts and alkaline earth metal hydroxide salts with a water-soluble polyvalent metal salt, which is not an alkaline earth metal hydroxide salt, in the aqueous medium.

As the alkali metal hydroxide salts, examples include, but are not limited to, lithium hydroxide, sodium hydroxide and potassium hydroxide. As the alkaline earth metal hydroxide salts, examples include, but are not limited to, barium hydroxide and calcium hydroxide.

The water-soluble polyvalent metal salt is only required to be a water-soluble polyvalent metal salt other than compounds corresponding to the above-mentioned alkaline earth metal hydroxide salts. As the polyvalent metal salt, examples include, but are not limited to, magnesium metal salts such as magnesium chloride, magnesium phosphate and magnesium sulfate; calcium metal salts such as calcium chloride, calcium nitrate, calcium acetate and calcium sulfate; aluminum metal salts such as aluminum chloride and aluminum sulfate; barium salts such as barium chloride, barium nitrate and barium acetate; and zinc salts such as zinc chloride, zinc nitrate and zinc acetate. Among them, magnesium metal salts, calcium metal salts and aluminum metal salts are preferred; magnesium metal salts are more preferred; and magnesium chloride is particularly preferred.

The method for reacting the water-soluble polyvalent metal salt with the at least one selected from the group consisting of alkali metal hydroxide salts and alkaline earth metal hydroxide salts in the aqueous medium, is not particularly limited. For example, an aqueous solution of the water-soluble polyvalent metal salt may be mixed with an aqueous solution of the at least one selected from the group consisting of alkali metal hydroxide salts and alkaline earth metal hydroxide salts.

Also, colloidal silica may be used as the colloidal dispersion containing the sparingly water-soluble inorganic dispersion stabilizer colloidal particles.

As the organic water-soluble polymer stabilizer, examples include, but are not limited to, polyvinyl alcohol, a polycarboxylic acid (such as polyacrylic acid), a cellulose (such as hydroxyethyl cellulose, carboxymethyl cellulose, methyl cellulose and ethyl cellulose), polyvinylpyrrolidone, polyacrylimide, polyethylene oxide and a poly(hydroxystearic acid-g-methyl methacrylate-co-methacrylic acid) copolymer.

As the inorganic water-soluble polymer stabilizer, examples include, but are not limited to, sodium tripolyphosphate.

The surfactant is a compound containing both a hydrophilic group and a hydrophobic group per molecule. As the surfactant, examples include, but are not limited to, a conventionally-known ionic surfactant such as an anionic surfactant, a cationic surfactant and an amphoteric surfactant, and a conventionally-known non-ionic surfactant.

For the water-soluble polymer stabilizer and the surfactant, the solubility in water at 25° C. is 1 g/L or more.

The content of the dispersion stabilizer is not particularly limited. With respect to the total mass (100 parts by mass) of the polymerizable monomer and the hydrophobic solvent, the content of the dispersion stabilizer is preferably from 0.5 parts by mass to 15 parts by mass, and more preferably from 1 part by mass to 10 parts by mass. When the content of the dispersion stabilizer is equal to or more than the lower limit value, the droplets of the monomer composition can be sufficiently dispersed in the suspension so that they do not join together. On the other hand, when the content of the dispersion stabilizer is equal to or less than the upper limit value, an increase in the viscosity of the suspension is prevented in the formation of the droplets, and a problem such that a droplet forming machine is clogged with the suspension, can be avoided.

With respect to 100 parts by mass of the aqueous medium, the content of the dispersion stabilizer is preferably from 0.5 parts by mass to 15 parts by mass, and more preferably from 0.5 parts by mass to 10 parts by mass.

In the present disclosure, from the viewpoint of suppressing a deterioration in the reactivity between the hollow particles and the base material elastomer, the amount of the residual dispersion stabilizer is preferably as small as possible. The hollow particles are most preferably free of the dispersion stabilizer. The hollow particles containing neither the water-soluble polymer stabilizer nor the surfactant are particularly preferred. By using only the inorganic dispersion stabilizer as the dispersion stabilizer, the hollow particles in which both the water-soluble polymer stabilizer and the surfactant are below the detection limit, can be obtained.

### (E) Aqueous Medium

In the present disclosure, the term “aqueous medium” means a medium selected from the group consisting of water, a hydrophilic solvent and a mixture thereof.

When a mixture of water and a hydrophilic solvent is used, from the viewpoint of forming the droplets of the monomer composition, it is important that the polarity of the entire mixture is not too low. In this case, for example, the mass ratio between water and the hydrophilic solvent (water:hydrophilic solvent) may be set to 99:1 to 50:50.

In the present disclosure, the hydrophilic solvent is not particularly limited, as long as it is one that mixes with water sufficiently and does not develop phase separation. As the hydrophilic solvent, examples include, but are not limited to, alcohols such as methanol and ethanol, tetrahydrofuran (THF), and dimethyl sulfoxide (DMSO).

The content of the aqueous medium is not particularly limited. From the viewpoint of controlling the particle diameter and void ratio of the hollow particles in the preferred ranges described below, with respect to 100 parts by mass of the polymerizable monomer contained in the mixture liquid, the content of the aqueous medium is, as the lower limit thereof, preferably 200 parts by mass or more, more preferably 400 parts by mass or more, and still more preferably 600 parts by mass or more. The content is, as the upper limit thereof, preferably 1000 parts by mass or less, and more preferably 800 parts by mass or less.

The mixture liquid may further contain other materials that are different from the above-mentioned materials (A) to (E), to the extent that does not impair the objects of the present disclosure.

The mixture liquid is obtained by mixing the above-mentioned materials and other materials as needed, appropriately stirring the mixture, etc. In the mixture liquid, an oil phase containing lipophilic materials such as (A) the polymerizable monomer, (B) hydrophobic solvent and (C) the polymerization initiator is dispersed with a size of a particle diameter of approximately several millimeters in an aqueous phase containing (D) the dispersion stabilizer, (E) the aqueous medium, etc. The dispersion state of these materials in the mixture liquid can be observed with the naked eye, depending on the types of the materials.

In the mixture liquid preparation step, the mixture liquid may be obtained by simply mixing the above-mentioned materials and other materials as needed, appropriately stirring the mixture, etc. From the point of view that the shell can be easily uniform, it is preferable to prepare the mixture liquid by separately preparing the oil phase, which contains the polymerizable monomer, the hydrophobic solvent and the polymerization initiator, and the aqueous phase, which contains the dispersion stabilizer and the aqueous medium, in advance, and then mixing the phases together. In the present disclosure, a colloidal dispersion in which a sparingly water-soluble inorganic dispersion stabilizer is dispersed in the form of colloidal particles in the aqueous medium, can be preferably used as the aqueous phase.

As just described, by separately preparing the oil phase and the aqueous phase in advance and then mixing them, hollow particles in which the composition of the shell portion is uniform, can be produced. Also, the particle diameter of the hollow particles can be easily controlled.

### (2) Suspension Step

The suspension step includes suspending the mixture liquid to prepare the suspension in which the droplets of the monomer composition containing the hydrophobic solvent are dispersed in the aqueous medium.

The suspension method for forming the droplets of the monomer composition is not particularly limited, and a known suspension method can be employed. A disperser is used to prepare the suspension. As the disperser, for example, a horizontal or vertical in-line disperser such as MILDER (manufactured by Pacific Machinery & Engineering Co., Ltd.), CAVITRON (manufactured by EUROTEC, Ltd.) and an in-line disperser manufactured by IKA (e.g., DISPAX-REACTOR (registered trademark) DRS) or an emulsifying disperser such as HOMOMIXER MARK II series (manufactured by PRIMIX Corporation) can be used.

In the dispersion for the preparation of the suspension, from the viewpoint of forming the hollow portion and controlling the volume average particle diameter of the hollow particles within the above-described preferred range, the rotational frequency of the disperser is preferably 100 rpm or more, more preferably 200 rpm or more, and still more preferably 300 rpm or more. On the other hand, from the viewpoint of decreasing the amount of the irregular-shaped particles, it is preferably 30000 rpm or less, more preferably 10000 rpm or less, and still more preferably 5000 rpm or less.

In the suspension prepared in the suspension step, the droplets of the monomer composition containing the lipophilic materials mentioned above and having a particle diameter of approximately from 0.1 μm to 100 μm, are dispersed uniformly in the aqueous medium. Such droplets of the monomer composition are difficult to observe with the naked eye and can be observed with a known observation instrument such as an optical microscope.

In the suspension step, since phase separation occurs in the droplets of the monomer composition, the hydrophobic solvent with low polarity is likely to collect in the interior of the droplets. As a result, in the obtained droplets, the hydrophobic solvent is distributed in the interior thereof, and the material not containing the hydrophobic solvent is distributed at the periphery thereof.

The droplets of the monomer composition dispersed in the aqueous medium are formed of the oil-soluble monomer composition and the dispersion stabilizer surrounding the periphery of the oil-soluble monomer The droplets of the monomer composition contain the oil-soluble polymerization initiator, the polymerizable monomer and the hydrophobic solvent.

The droplets of the monomer composition are minute oil droplets, and the oil-soluble polymerization initiator generates polymerization initiating radicals in the interior of the minute oil droplets. Therefore, the precursor particles having a target particle diameter can be produced without an excessive growth of the minute oil droplets.

In the suspension polymerization method using such an oil-soluble polymerization initiator, there is no opportunity for the polymerization initiator to come into contact with the polymerizable monomer dispersed in the aqueous medium. Therefore, by using the oil-soluble polymerization initiator, the subgeneration of surplus resin particles (e.g., solid particles having a relatively small particle diameter) in addition to the target resin particles having the hollow portion, can be suppressed.

### (3) Polymerization Step

The polymerization step includes subjecting the suspension to a polymerization reaction to prepare the precursor composition in which the precursor particles comprising the shell, which contains the resin, and the hollow portion, which is surrounded by the shell and filled with the hydrophobic solvent, are dispersed in the aqueous medium. The precursor particles are formed by polymerization of the polymerizable monomer contained in the droplets of the monomer composition, and the shell of the precursor particles contains the polymer of the polymerizable monomer as the resin.

The polymerization system is not particularly limited. For example, a batch system, a semicontinuous system or a continuous system may be employed.

The polymerization temperature is preferably from 40° C. to 90° C., and more preferably from 50° C. to 80° C.

The polymerization reaction time is preferably from 1 hour to 48 hours, and more preferably from 1 hour to 36 hours.

In the polymerization step, the shell portion of the droplets of the monomer composition, which contain the hydrophobic solvent in the interior, polymerizes. Accordingly, as described above, the hollow portion filled with the hydrophobic solvent is formed in the interior of the obtained precursor particles.

### (4) Solid-Liquid Separation Step

The solid-liquid separation step includes performing solid-liquid separation of the precursor composition which contains the precursor particles and which is obtained by the above-described polymerization step, to obtain a solid component containing the precursor particles.

The method of performing the solid-liquid separation of the precursor composition is not particularly limited, and a known method may be used. As the solid-liquid separation method, examples include, but are not limited to, a centrifugation method, a filtration method, and still-standing separation. Among them, a filtration method is preferred from the viewpoint of simplicity of the operation and high removal efficiency of the dispersion stabilizer.

Any step such as a preliminary drying step may be performed at a time after the solid-liquid separation step and before performing the solvent removal step described later. Examples of the preliminary drying step include performing preliminary drying on the solid component obtained after the solid-liquid separation step, by use of a drying apparatus such as a dryer and a drying appliance such as a hand dryer.

### (5) Solvent Removal Step

The solvent removal step includes removing the hydrophobic solvent from the precursor particles.

For example, after the solid-liquid separation step described above, the included hydrophobic solvent is removed from the precursor particles in a gaseous atmosphere. Accordingly, the hydrophobic solvent in the interior of the precursor particles is substituted with gas, and the hollow particles filled with gas are obtained.

In this step, the term “in a gaseous atmosphere” includes “in an environment where no liquid component exists in the outside of the precursor particles” and “in an environment where only a very small amount of liquid component at a level that does not influence the removal of the hydrophobic solvent, exists in the outside of the precursor particles” in a strict sense. The term “in a gaseous atmosphere” can be reworded as a state where the precursor particles do not exist in a slurry, or it can be reworded as a state where the precursor particles exist in a dry powder. That is, in this step, it is important to remove the hydrophobic solvent in an environment where the precursor particles come into direct contact with the outside gas.

The method of removing the hydrophobic solvent from the precursor particles in a gaseous atmosphere, is not particularly limited, and a known method may be employed. Examples of the method include a reduced pressure drying method, a heat drying method, a flash drying method, and the combination of these methods.

Especially, in the case of using the heat drying method, the heating temperature needs to be set to more than or equal to the boiling point of the hydrophobic solvent and less than or equal to the highest temperature at which the shell structure of the precursor particles does not collapse. Accordingly, depending on the composition of the shell and the type of the hydrophobic solvent in the precursor particles, the heating temperature may be from 50° C. to 200° C., may be from 70° C. to 200° C., or may be from 100° C. to 200° C., for example.

The hydrophobic solvent in the interior of the precursor particles is substituted with the outside gas by the drying operation in the gaseous atmosphere. As a result, the hollow particles in which the hollow portion is occupied by gas, are obtained.

The drying atmosphere is not particularly limited and may be appropriately selected depending on the intended application of the hollow particles. Possible examples of the drying atmosphere include air, oxygen, nitrogen and argon. Further, by filling the interior of the hollow particles with gas once and then performing reduced pressure drying, hollow particles in which the interior is evacuated are also temporarily obtained.

As another method, instead of subjecting the precursor composition obtained in the polymerization step, which is in the form of slurry, to solid-liquid separation, the included hydrophobic solvent may be removed from the precursor particles in the slurry containing the precursor particles and the aqueous medium.

In this method, for example, at a temperature equal to or more than the temperature obtained by subtracting 35° C. from the boiling point of the hydrophobic solvent, an inert gas is bubbled into the precursor composition. Accordingly, the hydrophobic solvent can be removed from the precursor particles.

When the hydrophobic solvent is a mixed solvent containing more than one type of hydrophobic solvent and it has more than one boiling point, the boiling point of the hydrophobic solvent in the solvent removal step is determined as the boiling point of the solvent having the highest boiling point among the solvents contained in the mixed solvent, that is, the highest boiling point of the more than one boiling point.

The temperature at the time of bubbling the inert gas into the precursor composition, is preferably a temperature equal to or more than the temperature obtained by subtracting 30° C. from the boiling point of the hydrophobic solvent, and more preferably a temperature equal to or more than the temperature obtained by subtracting 20° C. from the boiling point of the hydrophobic solvent, from the viewpoint of reducing the amount of the residual hydrophobic solvent in the hollow particles. The temperature at the time of bubbling is generally set to a temperature equal to or more than the polymerization temperature of the polymerization step. The temperature at the time of bubbling is not particularly limited, and it may be 50° C. or more and 100° C. or less.

The inert gas used for the bubbling is not particularly limited. As the inert gas, examples include, but are not limited to, nitrogen and argon.

Depending on the type and amount of the hydrophobic solvent, the bubbling condition is appropriately controlled so that the hydrophobic solvent can be removed from the precursor particles. The bubbling condition is not particularly limited. For example, the inert gas may be bubbled in an amount of 1 L/min to 3 L/min for 1 hour to 10 hours.

By this method, a slurry of the hollow particles including an inert gas is obtained. The slurry is subjected to solid-liquid separation to obtain hollow particles, and the residual aqueous medium is removed from the hollow particles, thereby obtaining the hollow particles in which the hollow portion is occupied by gas.

The method for obtaining the hollow particles in which the hollow portion is filled with gas, by subjecting the precursor composition in the form of slurry to solid-liquid separation and then removing the hydrophobic solvent from the precursor particles in the gaseous atmosphere, is compared to the method for obtaining the hollow particles in which the hollow portion is filled with gas, by removing, in the slurry containing the precursor particles and the aqueous medium, the hydrophobic solvent from the precursor particles, subjecting the slurry to solid-liquid separation, and then removing the residual aqueous medium from the hollow particles in the gaseous atmosphere. As a result, the former method is advantageous in that the hollow particles are less likely to collapse in the hydrophobic solvent removal step, and the latter method is advantageous in that the amount of the residual hydrophobic solvent is decreased by bubbling the inert gas.

Also, the hydrophobic solvent included in the precursor particles may be removed therefrom after the polymerization step and before the solid-liquid separation step, without the solid-liquid separation of the slurry precursor composition obtained in the polymerization step, by use of the following method, for example: evaporating the hydrophobic solvent included in the precursor particles from the precursor composition at a predetermined pressure (a high, normal or reduced pressure), or evaporating the hydrophobic solvent included in the precursor particles from the precursor composition by introducing water vapor or inert gas such as nitrogen, argon and helium to the precursor composition at a predetermined pressure (a high, normal or reduced pressure).

### (6) Other Steps

In addition to the steps (1) to (5) mentioned above, the following surface treatment step (6-a), sieving step (6-b), washing step (6-c) and particle interior substitution step (6-d) may be added, for example.

### (6-a) Surface Treatment Step

After the above-described polymerization step, the method for producing the hollow particles of the present disclosure may include a surface treatment step in which the outer surface of the shell is surface-treated with a coupling agent.

The coupling agent contains, per molecule, a functional group that can be bound to organic matters and a functional group that can be bound to inorganic matters, and it can increase the affinity between organic and inorganic materials.

The coupling agent is preferably such an agent, that the functional group in the molecular structure thereof is a functional group which is crosslinkable to the base material elastomer described below. The functional group crosslinkable to the base material elastomer is not particularly limited, and it is appropriately selected depending on the type of the base material elastomer. As the functional group, examples include, but are not limited to, a hydroxyl group, a carboxyl group, a carbonyl group, an amino group, a mercapto group, a halogen group, a vinyl group, a methacryloyl group, an acryloyl group, a siloxyl group, a peroxide group and an epoxy group. Of them, a carboxyl group, a carbonyl group and an epoxy group are preferred, and an epoxy group is particularly preferred.

As the coupling agent, examples include, but are not limited to, a silane coupling agent, a titanium coupling agent and an aluminum coupling agent.

As the silane coupling agent, examples include, but are not limited to, the following: an alkoxysilane containing a vinyl group, such as vinyltrimethoxysilane, vinyltriethoxysilane and vinyltris(β-methoxyethoxy) silane; an alkoxysilane containing a methacryloyl or acryloyl group, such as γ-acryloxypropyltrimethoxysilane and γ-methacryloxypropyltrimethoxysilane; an alkoxysilane containing an epoxy group, such as γ-glycidoxypropyltrimethoxysilane, β-(3,4-epoxycyclohexyl)ethyltrimethoxysilane and γ-glycidoxypropylmethyldiethoxysilane; an alkoxysilane containing an amino group, such as γ-aminopropyltriethoxysilane, N-β-(aminoethyl) γ-aminopropyltrimethoxysilane and N-β-(aminoethyl) γ-aminopropylmethyldimethoxysilane; an alkoxysilane containing a mercapto such as group, γ-mercaptopropyltrimethoxysilane; an alkoxysilane containing a halogen group, such as γ-chloropropyltrimethoxysilane; a silane containing a vinyl group and a halogen group, such as vinyltrichlorosilane; and methyltriacetoxysilane.

As the titanium coupling agent, examples include, but are not limited to, the following: isopropyl triisostearoyl titanate, isopropyl tridodecyl benzene sulfonyl titanate, isopropyl tris(dioctyl pyrophosphate) titanate, tetraisopropyl bis(dioctyl phosphite) titanate, tetraoctyl bis(ditridecylphosphite) titanate, tetra(2,2-diallyloxymethyl-1-butyl)bis(ditridecyl)phosphite titanate, bis(dioctyl pyrophosphate)oxyacetate titanate, bis(dioctyl pyrophosphate)ethylene titanate, isopropyl trioctanoyl titanate, isopropyl dimethacryl isostearoyl titanate, isopropyl isostearoyl diacryl titanate, isopropyl tri (dioctyl phosphate) titanate, isopropyl tri (N-amidoethyl amino ethyl) titanate, dicumylphenyloxyacetate titanate and diisostearoyl ethylene titanate.

As the aluminum coupling agent, examples include, but are not limited to, acetoalkoxy aluminum diisopropylate.

Of them, the silane coupling agent is preferred. Particularly preferred is an alkoxysilane containing an epoxy group, such as Y-glycidoxypropyltrimethoxysilane, β-(3,4-epoxycyclohexyl)ethyltrimethoxysilane and Y-glycidoxypropylmethyldiethoxysilane.

The coupling agent is used as it is, or it is dissolved in a solvent before use.

The hollow particles used in the present disclosure may have a polar group on the surface, such as an amino group and an acidic group. As the method for introducing the polar group to the particle surface, examples include, but are not limited to, the following: a method of reacting a modifier for introducing the polar group, a method of surface-treating the hollow particles with a coupling agent containing a polar group, and a method of using a polymerizable monomer containing a polar group.

### (6-b) Sieving Step (Aggregate Removal Step)

The method for producing the hollow particles of the present disclosure preferably includes a sieving step after the solvent removal step described above. Coarse powder particles and aggregates can be removed by the sieving step, and foreign materials can be easily removed, accordingly.

The sieving method is not particularly limited, and a known method can be employed. For example, sieving may be carried out with a metal mesh such as a stainless mesh or with a resin mesh such as a nylon mesh. More specifically, the hollow particles are put on the mesh; the mesh is vibrated; and the hollow particles passed through the mesh are obtained, thereby obtaining the hollow particles thus sieved. The size of the openings of the mesh used in the sieving step, is appropriately selected depending on the size of the hollow particles. The size of the openings is preferably a size such that the percentage of particles having a circularity of 0.85 or less is less than 15% by mass of the obtained hollow particles.

### (6-c) Washing Step

The washing step includes adding acid or alkali to the slurry containing the precursor particles or the hollow particles and washing the particles for removal of the dispersion stabilizer remaining in the precursor particles or the hollow particles. When the dispersion stabilizer used is an acid-soluble inorganic dispersion stabilizer, acid is preferably added to the slurry containing the precursor particles or the hollow particles to wash the particles. When the dispersion stabilizer used is an alkali-soluble inorganic compound, alkali is preferably added to the slurry containing the precursor particles or the hollow particles to wash the particles.

When the acid-soluble inorganic dispersion stabilizer is used as the dispersion stabilizer, the pH of the slurry containing the precursor particles or the hollow particles is preferably adjusted to 6.5 or less, and more preferably 6 or less, by adding acid to the slurry. As the added acid, an inorganic acid such as sulfuric acid, hydrochloric acid and nitric acid or an organic acid such as formic acid and acetic acid may be used. Of them, sulfuric acid is particularly preferred, due to its high dispersion stabilizer removal efficiency and small influence on production equipment.

### (6-d) Particle Interior Substitution Step

The particle interior substitution step includes substituting the gas or liquid in the interior of the hollow particles with another gas or liquid. By such substitution, the environment of the interior of the hollow particles can be changed; molecules can be selectively confined in the interior of the hollow particles; or the chemical structure of the interior of the hollow particles can be modified in accordance with the intended application.

### 3. Elastomer Composition

The elastomer composition of the present disclosure contains the above-described hollow particles of the present disclosure and a base material elastomer, and it is used as a molding material for producing the elastomer crosslinked molded body.

By the elastomer composition of the present disclosure, a light-weight elastomer crosslinked molded body having a reduced compression set is provided.

### [Hollow Particles]

The hollow particles contained in the elastomer composition of the present disclosure are the above-described hollow particles of the present disclosure.

The content of the hollow particles contained in the elastomer composition of the present disclosure is not particularly limited. With respect to 100 parts by mass of the base material elastomer, the content of the hollow particles is preferably 10 parts by mass or more, more preferably 15 parts by mass or more, and still more preferably 20 parts by mass or more as the lower limit. On the other hand, it is preferably 200 parts by mass or less, more preferably 150 parts by mass or less, and still more preferably 100 parts by mass or less as the upper limit. When the content of the hollow particles is equal to or more than the lower limit value, the weight reduction effect and the effect of reducing the compression set of the molded body, which are exerted by the hollow particles, are excellent. When the content of the hollow particles is equal to or less than the upper limit value, a deterioration in the dispersibility of the hollow particles is suppressed, and the effect of reducing the compression set of the molded body is excellent, accordingly; moreover, an elastomer composition having excellent rubber properties is obtained, since the base material elastomer can be sufficiently contained.

### [Base Material Elastomer]

As a base material, the elastomer composition of the present disclosure contains an elastomer, that is, a polymer having rubber elasticity. In the present disclosure, the elastomer contained as the base material of the elastomer composition is referred to as “base material elastomer”.

The base material elastomer is not particularly limited. As the base material elastomer, examples include, but are not limited to, rubber and a thermoplastic elastomer.

As the rubber, examples include, but are not limited to, natural rubber, isoprene rubber, butadiene rubber, styrene-butadiene rubber, chloroprene rubber, acrylonitrile-butadiene rubber (NBR), hydrogenated acrylonitrile-butadiene rubber (HNBR), ethylene-α-olefin copolymer rubber, ethylene-α-olefin-non-conjugated diene copolymer rubber (e.g., an ethylene-propylene-dien terpolymer (EPDM)), halogenated ethylene-α-olefin-non-conjugated diene copolymer rubber, sulfonated ethylene-α-olefin-non-conjugated diene copolymer rubber, maleated ethylene-α-olefin-non-conjugated diene copolymer rubber, butyl rubber, isobutylene-isoprene rubber, urethane rubber, silicone rubber, chloro-sulfonated polyethylene rubber, acrylic rubber, epichlorohydrin rubber, fluorine rubber, polysulfide rubber and propylene oxide rubber.

The thermoplastic elastomer is generally a polymer having the following characteristics: it shows rubber elasticity at ordinary temperature (25° C.), and it can be plasticized and molded at high temperature. As the thermoplastic elastomer, a thermoplastic elastic polymer which is conventionally used as a molding resin can be used, such as an urethane-based elastomer, a styrene-based elastomer, an olefin-based elastomer, an amide-based elastomer and an ester-based elastomer.

These base material elastomers may be used alone or in combination of two or more.

In the elastomer composition of the present disclosure, one having an iodine value of 5 g/100 g or more is preferably selected from these base material elastomers and used. Accordingly, sufficient amounts of crosslinks are formed between the hollow particles and the base material elastomer, and such a molded body is obtained, that the compression set is sufficiently reduced. The iodine value of the base material elastomer is more preferably 10 g/100 g or more, and still more preferably 15 g/100 g or more. The upper limit of the iodine value of the base material elastomer is not particularly limited, and it is preferably 50 g/100 g or less, more preferably 40 g/100 g or less, and still more preferably 30 g/100 g or less.

As the base material elastomer, at least one selected from the group consisting of the following is preferably contained: ethylene-α-olefin-non-conjugated diene copolymer rubber, butadiene rubber, styrene-butadiene rubber, natural rubber, isoprene rubber, acrylonitrile-butadiene rubber, hydrogenated acrylonitrile-butadiene rubber, butyl rubber, fluorine rubber, silicone rubber, acrylonitrile-butadiene rubber, chloroprene rubber, acrylic rubber, chloro-sulfonated polyethylene rubber, chlorinated polyethylene rubber, urethane rubber, isobutylene-isoprene rubber, polysulfide rubber, propylene oxide rubber and epichlorohydrin rubber. As the base material elastomer, at least one selected from the group consisting of the following is more preferably contained: ethylene-α-olefin-non-conjugated diene copolymer rubber, butadiene rubber, styrene-butadiene rubber, natural rubber, isoprene rubber, acrylic rubber, acrylonitrile-butadiene rubber and hydrogenated acrylonitrile-butadiene rubber. As the base material elastomer, at least one selected from the group consisting of ethylene-α-olefin-non-conjugated diene copolymer rubber, acrylonitrile-butadiene rubber and hydrogenated acrylonitrile-butadiene rubber is still more preferably contained. As the base material elastomer, ethylene-α-olefin-non-conjugated diene copolymer rubber is particularly preferably contained.

The content of the above-described preferred base material elastomer preferably accounts for 50% by mass or more, more preferably 70% by mass or more, still more preferably 90% by mass or more, and particularly preferably 100% by mass of the whole base material elastomer (100% by mass).

The ethylene-α-olefin-non-conjugated diene copolymer rubber is a random copolymer of ethylene, α-olefin and non-conjugated diene. As the α-olefin, examples include, but are not limited to, propylene, 1-butene, 1-pentene, 3-methyl-1-pentene, 4-methyl-1-pentene, 1-hexene, 1-heptene, 1-octene, 1-nonene, 1-decene, 1-undecene and 1-dodecene. Of them, propylene, 1-hexene and 1-octene are preferred, and propylene is particularly preferred. These α-olefins may be used alone or in combination of two or more. The molar ratio of the ethylene to the α-olefin (ethylene/α-olefin) is not particularly limited. It is preferably from 40/60 to 95/5, more preferably from 50/50 to 85/15, and still more preferably from 60/40 to 80/20.

As the non-conjugated diene, examples include, but are not limited to, 1,4-hexadiene, 3-methyl-1,4-hexadiene, 1,7-octadiene, 1,9-decadiene, 5-ethylidene-2-norbornene, 5-isopropylidene-2-norbornene, 5-isobutenyl-2-norbornene, cyclopentadiene, dicyclopentadiene and norbornadiene. Of them, 5-ethylidene-2-norbornene and dicyclopentadiene are preferred. These non-conjugated dienes may be used alone or in combination of two or more.

### [Crosslinking Agent]

The elastomer composition of the present disclosure may contain a crosslinking agent for crosslinking the base material elastomer. As the crosslinking agent, examples include, but are not limited to, sulfur such as powdery sulfur, precipitated sulfur, colloidal sulfur and insoluble sulfur; a sulfur-containing inorganic compound such as sulfur chloride, selenium and tellurium; a sulfur-containing organic compound such as morpholine disulfide, an alkylphenol disulfide, a thiuram disulfide and dithiocarbamate; and an organic peroxide such as 1,1-di-t-butylperoxy-3,3,5-trimethylcyclohexane, di-t-butylperoxide, dicumyl peroxide, t-butyl cumyl peroxide, 2,5-dimethyl-2,5-di(t-butylperoxy) hexane and 1,3-bis-(t-butylperoxy-isopropyl)benzene. These crosslinking agents may be used alone or in combination of two or more.

The content of the crosslinking agent is appropriately selected, depending on its type. With respect to 100 parts by mass of the base material elastomer, the content of the crosslinking agent is generally in a range of from 0.1 parts by mass to 10 parts by mass, and preferably in a range of from 0.5 parts by mass to 5 parts by mass.

### [Other Components]

As needed, the elastomer composition of the present disclosure may contain additives such as a plasticizer (a softening agent), a reinforcing agent, a filler, a vulcanization accelerator, an auxiliary a vulcanization accelerator, processing aid, an antioxidant, a UV absorber, a foaming agent, an auxiliary foaming agent, a lubricant, a pigment, a colorant, a dispersant and a flame retardant, to the extent that does not impair the objects of the present disclosure.

The reinforcing agent and filler contained in the elastomer composition of the present disclosure may be surface-treated with the above-described coupling agent that are applicable to the hollow particles of the present disclosure. At least one selected from the group consisting of the reinforcing agent and the filler is preferably surface-treated with the coupling agent, since the mechanical properties of the elastomer crosslinked molded body, such as tensile strength, tensile stress, tearing strength and abrasion resistance, are improved. More preferably, the hollow particles of the present disclosure and at least one selected from the group consisting of the reinforcing agent and the filler, are surface-treated with the coupling agent.

As the plasticizer (softening agent), one that is generally used as a plasticizer or softening agent in applications such as an in-vehicle material, a common plastic and a rubber product, or one that has flexibility imparting properties can be used. As the plasticizer (softening agent), examples include, but are not limited to, the following: a petroleum softening agent such as process oil, lubricating oil, paraffin, liquid paraffin, petroleum asphalt and petrolatum; a coal tar-based softening agent such as coal tar and coal tar pitch; a fatty oil-based softening agent such as castor oil, linseed oil, canola oil and palm oil; tall oil; wax such as beeswax, carnauba wax and lanolin; fatty acid and fatty acid salt such as ricinoleic acid, palmitic acid, barium stearate, calcium stearate and zinc laurate; a synthetic polymer substance such as petroleum resin, atactic polypropylene and coumarone-indene resin; an ester-based plasticizer such as dioctyl phthalate, dioctyl adipate and dioctyl sebacate; a carbonate ester-based plasticizer such as diisododecyl carbonate; and other plasticizers such as microcrystalline wax, a rubber substitute (factice), liquid polybutadiene, modified liquid polybutadiene, liquid Thiokol and hydrocarbon-based synthetic lubricating oil. These plasticizers may be used alone or in combination of two or more.

The content of the plasticizer (softening agent) in the elastomer composition is not particularly limited. With respect to 100 parts by mass of the base material elastomer, it is generally from 10 parts by mass to 200 parts by mass, preferably from 35 parts by mass to 100 parts by mass, and more preferably from 45 parts by mass to 90 parts by mass.

The reinforcing agent is effective in improving the mechanical properties of elastomers, such as tensile strength, tensile stress, tearing strength and abrasion resistance. In a crosslinked molded body containing the reinforcing agent, bound rubber is formed at the interface of the reinforcing agent, and these mechanical properties are estimated to be improved, accordingly.

As the reinforcing agent, examples include, but are not limited to, silica, and carbon black such as SRF, GPF, FEF, FF, HAF, HAF-LS, HAF-HS, ISAF, ISAF-LS, ISAF-HS, SAF, FT and MT. As the silica, examples include, but are not limited to, natural silica such as quartz powder and silica stone powder, and synthetic silica such as silicic anhydride (e.g., silica-gel, AEROSIL), hydrous silicic acid, hydrous silicate and pulverized silicic acid. These reinforcing agents may be used alone or in combination of two or more.

The content of the reinforcing agent is not particularly limited. With respect to 100 parts by mass of the base material elastomer, it is generally less than 230 parts by mass. From the viewpoint of improving the mechanical properties of the crosslinked molded body, with respect to 100 parts by mass of the base material elastomer, the content of the reinforcing agent is preferably 1 part by mass or more, more preferably 3 parts by mass or more, and still more preferably 5 parts by mass or more. On the other hand, from the viewpoint of facilitating the kneading of the elastomer composition, the content of the reinforcing agent is preferably 15 parts by mass or less, more preferably 12 parts by mass or less, and still more preferably 10 parts by mass or less.

As the carbon black, carbon black having a nitrogen adsorption specific surface area of 5 m²/g or more and 150 m²/g or less is preferably used. From the viewpoint of excellent compatibility with the base material elastomer, carbon black having a nitrogen adsorption specific surface area of 5 m²/g or more and less than 25 m²/g is more preferably used. From the viewpoint of compatibility with the base material elastomer. The nitrogen adsorption specific surface area of the carbon black is more preferably 5 m²/g or more and 20 m²/g or less, still more preferably 5 m²/g or more and 15 m²/g or less, and particularly preferably 5 m²/g or more and 10 m²/g or less.

The above-described exemplary carbon blacks have nitrogen adsorption specific surface area in a range of from 5 m²/g or more and 150 m²/g or less. Of them, FT carbon (nitrogen adsorption specific surface area: 13 m²/g) and MT carbon (nitrogen adsorption specific surface area: 7 m²/g) are preferred since their nitrogen adsorption specific surface areas are 5 m²/g or more and less than 25 m²/g. MT carbon is particularly preferably used.

The nitrogen adsorption specific surface area of the carbon black is measured in accordance with JIS K6217-2.

As the reinforcing agent, at least one selected from the group consisting of the carbon black and silica is preferably used, since they are excellent in improving the mechanical properties of the crosslinked molded body. The carbon black is preferred, since it is particularly effective in improving the mechanical properties of the crosslinked molded body, and it is also effective in reducing the compression set of the crosslinked molded body. On the other hand, the crosslinked molded body is blackened when mixed with the carbon black. Therefore, in applications in which blackening of the crosslinked molded body is allowable, the carbon black is preferably used as the reinforcing agent. Meanwhile, in applications in which blackening of the crosslinked molded body is not allowable, silica is preferably used as the reinforcing agent. As just described, the type of the reinforcing agent may be appropriately selected depending on the intended application of the crosslinked molded body.

As described above, the reinforcing agent may be surface-treated with the coupling agent that is applicable to the hollow particles. In applications in which blackening of the crosslinked molded body is not allowable, coupling agent-treated silica is particularly preferably used as the reinforcing agent.

As the filler, examples include, but are not limited to, an inorganic filler such as calcium carbonate, light calcium carbonate, heavy calcium carbonate, magnesium carbonate, talc, clay, glass beads and glass balloons, and an organic filler such as high-styrene resin, coumarone-indene resin, phenolic resin, lignin, modified melamine resin and petroleum resin. Of them, the inorganic filler is preferably used. These fillers may be used alone or in combination of two or more.

The content of the filler is not particularly limited, with respect to 100 parts by mass of the base material elastomer, it is generally from 30 parts by mass to 200 parts by mass.

As the vulcanization accelerator, examples include, but are not limited to, an aldehyde ammonia such as hexamethylenetetramine; a guanidine such as diphenyl guanidine, di(o-tolyl) guanidine and o-tolyl-biguanide; a thiourea such as thiocarbanilide, di(o-tolyl)thiourea, N,N′-diethylthiourea and dilauryl thiourea; a thiazole such as mercaptobenzothiazole, dibenzothiazole disulfide and N,N′-di(ethylthiocarbamoylthio) benzothiazole; a sulfenamide such as N-t-butyl-2-benzothiazyl sulfenamide; a thiuram such as tetramethylthiuram disulfide, tetraethylthiuram disulfide, tetrabutylthiuram disulfide and tetramethylthiuram monosulfide; a carbamate such as zinc dimethylthiocarbamate, sodium dimethyldithiocarbamate, copper dimethyldithiocarbamate, tellurium dimethylthiocarbamate and iron dimethylthiocarbamate; and a xanthate such as butylthioxanthate. These vulcanization accelerators may be used alone or in combination of two or more.

With respect to 100 parts by mass of the base material elastomer, the content of the vulcanization accelerator is generally in a range of from 0.1 parts by mass to 20 parts by mass, and preferably in a range of from 0.2 parts by mass to 10 parts by mass.

As the auxiliary vulcanization accelerator, examples include, but are not limited to, a metal oxide such as magnesium oxide and zinc oxide, and an organic acid (salt) such as stearic acid, oleic acid and zinc stearate. Of them, zinc oxide and stearic acid are preferred. These auxiliary vulcanization accelerators may be used alone or in combination of two or more.

With respect to 100 parts by mass of the base material elastomer, the content of the auxiliary vulcanization accelerator is generally in a range of from 0.5 parts by mass to 20 parts by mass.

As the processing aid, examples include, but are not limited to, a higher fatty acid such as ricinoleic acid, stearic acid, palmitic acid and lauric acid; a salt of a higher fatty acid such as barium stearate, zinc stearate and calcium stearate; and an ester of a higher fatty acid such as ricinoleic acid, stearic acid, palmitic acid and lauric acid. As the antioxidant, examples include, but are not limited to, an amine-based antioxidant, a hindered phenol-based antioxidant and a sulfur-based antioxidant.

As the lubricant, examples include, but are not limited to, compounds such as a hydrocarbon (e.g. liquid paraffin), a fatty acid (e.g. stearic acid), a fatty acid amide (e.g. amide stearate), an ester (e.g. butyl stearate) and an alcohol (e.g. stearyl alcohol), mixtures thereof, and metallic soap.

As the pigment, examples include, but are not limited to, an inorganic pigment such as titanium dioxide, zinc oxide, ultramarine blue, colcothar, lithopone, lead, cadmium, iron, cobalt, aluminum, hydrochloride and nitrate, and an organic pigment such as an azo pigment, a phthalocyanine pigment, a quinacridone pigment, a quinacridonequinone pigment, a dioxazine pigment, an anthrapyrimidine pigment, an anthanthrone pigment, an indanthrone pigment, a flavanthrone pigment, a perylene pigment, a perinon pigment, a diketopyrrolopyrrole pigment, a quinonaphthalone pigment, an anthraquinone pigment, a thioindigo pigment, a benzimidazolone pigment, an isoindoline pigment and carbon black.

The crosslinked molded body obtained by using the elastomer composition of the present disclosure as the molding material and by employing a melt molding method or the like, may be a part formed of an elastomer, an elastomer part integrally formed with another material part, a coating film, or a tipping material for filling, for example.

The molded body obtained by crosslinking molding the elastomer composition of the present disclosure, is a light-weight molded body having a reduced compression set, since it contains the hollow particles of the present disclosure.

As the application of the elastomer crosslinked molded body produced by use of the elastomer composition of the present disclosure, examples include, but are not limited to, various kinds of rubber parts used in various kinds of fields such as the automotive field, the electronics field, the electric field, the architecture field, the aviation field and the space field. More specifically, examples include, but are not limited to, an automotive part such as a hose, a sealing material, a vibration isolation rubber and a weather strip; a building material such as a waterproof sheet and a sealing material; an electrical rubber part such as a high-voltage cable and a connector; and an industrial product such as a heat-resistant conveyor belt, a chemical-resistant roller and a heat-resistant hose. A sealing material is especially required to have a small compression set, since the sealing properties of the material deteriorates when the material is plastically deformed. The elastomer crosslinked molded body containing the hollow particles of the present disclosure is particularly preferably used in applications required to have a small compression set, such as a sealing material, since the compression set of the elastomer crosslinked molded body is reduced.

In addition, as the applications of the resin composition of the present disclosure, examples include, but are not limited to, the following: an overcoating or undercoating material which is required have heat insulation properties and shock-absorbing properties (cushioning properties), a shock-absorbing material (cushioning material) for footwears such as sports shoes and sandals, household appliance parts, bicycle parts, stationery supplies, tools, filaments of 3D printers, and floating buoyant materials such as syntactic foam.

### [Method for Producing the Elastomer Composition]

The method for producing the elastomer composition of the present disclosure is not particularly limited, and a common method may be employed. As the method for producing the elastomer composition of the present disclosure, examples include, but are not limited to, the following method: while the base material elastomer is kneaded, the hollow particles of the present disclosure and other components added as needed, such as a crosslinking agent, are added thereto, and the base material elastomer is further kneaded, thereby preparing the elastomer composition. Also, the following method can be used: a raw material mixture containing the base material elastomer, the hollow particles of the present disclosure and other components added as needed, such as a crosslinking agent, is prepared, and the raw material mixture is kneaded, thereby preparing the elastomer composition.

The kneading of the base material elastomer or the raw material mixture is carried out at a temperature at which the base material elastomer softens. As a kneader used for the kneading, a known kneader such as a uniaxial kneader, a biaxial kneader, a kneader, a Banbury mixer, a pressure kneader and a roll kneader can be used. The kneading is preferably kneading that can apply high shear force, such as roll kneading. For roll kneading, a two-mixing roll can be used as the kneader, such as MIXING ROLL DY6-15 (manufactured by Daihan, Co., Ltd.)

Also in the production of the elastomer composition of the present disclosure, after pre-kneading the base material elastomer at the temperature at which the base material elastomer softens to uniformize the components of the base material elastomer, finishing kneading of the base material elastomer may be performed with high shear force, such as roll kneading. Accordingly, the elastomer composition in which the components are further uniformized and refined, can be obtained.

In the case of crosslinking molding the elastomer composition, the elastomer composition before being cross-linked can be recovered from a molding apparatus and reused as the raw material mixture.

The condition of kneading the base material elastomer or the raw material mixture is not particularly limited. In the case of using a radical initiator as the crosslinking agent, the kneading temperature is preferably equal to or less than the 10-hour half-life temperature of the crosslinking agent (radical initiator). The kneading temperature is the preset temperature of the kneader. The kneading time is preferably one hour or less. In such kneading condition, the crosslinking reaction of the base material elastomer can be prevented during kneading; scorching can be prevented; and the components can uniformly mixed.

For example, the kneading can be carried out by the following method. Using a roll kneader, the kneading temperature is set to 70° C. to 90° C. After the temperature of the kneader is stabilized, the base material elastomer is fed into the kneader. Then, while rotating the rotor of the kneader at a rotational frequency of from 10 rpm to 35 rpm, the components such as the hollow particles and the crosslinking agent are added in a desired order. After the end of the addition, all the materials are kneaded for 10 to 30 minutes. Accordingly, the elastomer composition of the present disclosure is obtained.

### 4. Elastomer Crosslinked Molded Body

The elastomer crosslinked molded body of the present disclosure is a molded body obtained by crosslinking molding the above-described elastomer composition of the present disclosure.

By crosslinking molding the elastomer composition of the present disclosure, the crosslinking reaction of the base material elastomer proceeds; moreover, the reactive unsaturated bonds of the hollow particles react with the reactive unsaturated bonds of the base material elastomer to form crosslinks. Accordingly, the elastomer crosslinked molded body of the present disclosure is obtained.

The method for crosslinking molding the elastomer composition can be appropriately selected from known methods, depending on the following: the type of the base material elastomer, the type and content of the hollow particles and other additives, and the shape of the target molded body. Known methods for crosslinking molding the elastomer composition include, for example, melt molding methods such as extrusion molding, compression molding, extrusion lamination molding, injection molding, press molding and blow molding.

The crosslinking molding temperature of the elastomer composition of the present disclosure is not particularly limited. From the viewpoint of sufficiently developing the crosslinking reaction of the base material elastomer and the reaction between the hollow particles and the base material elastomer, in the case of using the radical initiator as the crosslinking agent, the crosslinking molding temperature is preferably equal to or more than the 10-hour half-life temperature of the crosslinking agent. The upper limit of the crosslinking molding temperature of the elastomer composition of the present disclosure is not particularly limited. In the case of using the radical initiator as the crosslinking agent, the upper limit is preferably equal to or less than the one minute half-life temperature.

As the condition of crosslinking molding the elastomer composition of the present disclosure, for example, the pressure may be, but is not limited to, from 1 MPa to 20 MPa, and the hot-pressing time may be, but is not limited to, from one minute to 180 minutes.

The form of the elastomer crosslinked molded body of the present disclosure is not particularly limited. For example, the elastomer composition in a molten state may be molded into a form such as a long sheet form, a block form and a filler form, or it may be fabricated into a form such as a roll form (obtained by rolling up a long sheet) and a strip form (obtained by cutting a long sheet into a strip of predetermined length).

The compression set of the elastomer crosslinked molded body of the present disclosure, which is measured by the room temperature test in accordance with JIS K 6262:2013, is preferably less than 60%, and more preferably less than 40%. The lower limit of the compression set of the elastomer crosslinked molded body of the present disclosure, is not particularly limited, and it is generally 10% or more.

The compression set of the elastomer composition of the present disclosure before the crosslinking molding, which is used as a material for molding the elastomer crosslinked molded body of the present disclosure, is generally 60% or more.

### EXAMPLES

Hereinbelow, the present disclosure is described more specifically using examples and comparative examples. However, the present disclosure is not limited to these examples. Also, “part(s)” and “%” are on a mass basis unless otherwise specified.

### Preparation of Hollow Particles

### Production Example 1 (Hollow Particles A)

### (1) Mixture Liquid Preparation Step

First, the following materials were mixed to produce an oil phase.
Crosslinkable acrylic monomer: Ethylene glycol dimethacrylate 25 parts
Crosslinkable acrylic monomer: Trimethylolpropane trimethacrylate 30 parts
Crosslinkable hydrocarbon monomer: Divinylbenzene 45 parts
Oil-soluble polymerization initiator: 2,2′-azobis(2,4-dimethylvaleronitrile) 3 parts
Hydrophobic solvent: Hexane 160 parts

Meanwhile, in a stirring tank at room temperature, an aqueous solution in which 12.1 parts of sodium hydroxide (an alkali metal hydroxide) was dissolved in 121 parts of deionized water, was gradually added under stirring to an aqueous solution in which 17.1 parts of magnesium chloride (a water-soluble polyvalent metal salt) was dissolved in 494 parts of deionized water, thereby preparing a magnesium hydroxide (sparingly water-soluble metal hydroxide) colloidal dispersion (magnesium hydroxide: 4 parts). The dispersion was used as an aqueous phase.

The obtained aqueous phase and oil phase were mixed, thereby preparing a mixture liquid.

### (2) Suspension Step

The mixture liquid obtained in the mixture liquid preparation step was suspended by stirring with a disperser (product name: HOMOMIXER, manufactured by: PRIMIX Corporation) at a rotational frequency of 4,000 rpm for one minute, thereby preparing a suspension in which droplets of a monomer composition including the hydrophobic solvent were dispersed in water.

### (3) Polymerization Step

A polymerization reaction was carried out by stirring the suspension obtained in the suspension step for one and half hours in a nitrogen atmosphere at a temperature of 65° C., thereby obtaining a precursor composition in which precursor particles including the hydrophobic solvent were contained.

### (4) Washing Step and Solid-Liquid Separation Step

The precursor composition was washed with dilute sulfuric acid (25° C., 10 minutes) to bring the pH of the composition to 5.5 or less. Next, water was separated therefrom by filtration. Then, 200 parts of deionized water was added to reslurry the resultant, and a water washing treatment (washing, filtering and dehydrating) was repeatedly performed more than one times at room temperature (25° C.). The resultant was separated by filtration, thereby obtaining a solid component. The obtained solid component was dried with a dryer at a temperature of 40° C., thereby obtaining precursor particles including the hydrophobic solvent.

### (5) Solvent Removal Step

The precursor particles obtained in the solid-liquid separation step were subjected to heating treatment for 12 hours with a vacuum dryer in a nitrogen atmosphere at 200° C., thereby removing the included hydrophobic solvent from the particles. Accordingly, hollow particles were obtained.

### (6) Sieving Step

The hollow particles obtained in the solvent removal step were sieved with a nylon mesh having an opening size of 100 μm. The hollow particles passed through and dropped from the mesh were collected, thereby removing coarse particles therefrom and obtaining hollow particles A.

### Production Example 2 (Hollow Particles B)

The hollow particles of Production Example 2 (hollow particles B) were obtained in the same manner as Production Example 1, except that in “(1) Mixture liquid preparation step”, the amount of the polymerizable monomer added to the oil phase was changed according to Table 1.

### Production Example 3 (Hollow Particles C)

The hollow particles of Production Example 3 (hollow particles C) were obtained in the same manner as Production Example 1, except that in “(2) Suspension step”, the rotational frequency of the disperser was changed to 400 rpm.

### Production Example 4 (Hollow Particles D)

The hollow particles of Production Example 4 (hollow particles D) were obtained in the same manner as Production Example 1, except that in “(1) Mixture liquid preparation step”, the amount of the polymerizable monomer added to the oil phase was changed according to Table 1.

### Comparative Production Example 1 (Hollow Particles E)

The hollow particles of Comparative Production Example 1 (hollow particles E) were obtained in the same manner as Production Example 1, except that in “(1) Mixture liquid preparation step”, the polymerizable monomer added to the oil phase was changed to 100 parts of divinylbenzene only.

### Comparative Production Example 2 (Solid Particles A)

The solid particles of Comparative Production Example 2 (solid particles A) were obtained in the same manner as Production Example 1, except that in “(2) Suspension step”, the rotational frequency of the disperser was changed to 10 rpm.

### [Evaluation for Physical Properties of Particles]

The physical properties of the hollow particles obtained in Production Examples 1 to 4 and Comparative Production Example 1 and those of the solid particles obtained in Comparative Production Example 2 were evaluated as follows. Carbon particles were used in Comparative Example 3 described below, and only the iodine value and volume average particle diameter thereof were measured as follows. The results of evaluating the physical properties of the particles are shown in Table 1.

### 1. Measurement of Iodine Value

The iodine value of the particles was measured accordance with JIS K 0070. The details of the measurement in method were as follows.

First, 0.7 g to 2 g of the particles (sample) and 10 mL of chloroform were put in a 300 mL iodine flask. In addition, 25 mL of Wijs reagent was added thereto as a reaction solution. After lightly stirring the mixture, the flask was sealed and then left to stand for 30 minutes in a dark place at 25° C. Next, 20 mL of a 100 g/L potassium iodide solution and 100 mL of purified water were added thereto, and the mixture was stirred. Titration was carried out by use of a buret and a titrant (a 0.1 mol/L sodium thiosulfate solution). An indicator (a 1% starch solution) was added when the solution turned light yellow. The titration was continued until the blue color disappeared, and this point of time was regarded as the endpoint. Separately from this main test, a blank test was performed on a solution that was free of the particles, and the iodine value of the particles was calculated by the following formula. The iodine value is a value obtained as follows: halogen is reacted with 100 g of a sample, and the amount of halogen thus binding to the sample is converted to the grams of iodine, thereby obtaining the iodine value.

$$Iodine value ( g / 100 g ) = \{ ( {V}_{0} - {V}_{1} ) \times f \times 1.269 \} / S$$

$$S : Mass ( g ) of the sample$$

$${V}_{1} : Titrant amount ( mL ) in the main test$$

$${V}_{0} : Titrant amount ( mL ) in the blank test$$

$$f : Factor of the titrant$$

### 2. Percentage (%) of Particles Having One Hollow Portion

The particles were fixed on a carbon tape. The fixed particles were intentionally broken by rubbing them with a cotton swab. The interior of 100 of the broken particles was observed by SEM. The number of hollow portions per particle was specified, and the percentage (%) of the number of particles having only one hollow portion was calculated.

### 3. Percentage of Irregular-Shaped Particles

A mixed solution was obtained by adding 0.10 g to 0.12 g of the hollow particles to a linear alkylbenzene sulfonate aqueous solution (concentration 0.3%) and subjected to a dispersion treatment for 5 minutes by an ultrasonic cleaner, thereby preparing a measurement sample. Using a flow particle image analyzer (product name: IF-3200, manufactured by JASCO International Co., Ltd.), the particles contained in the measurement sample were measured for circularity in the following measurement conditions. The percentage by mass of the particles having a circularity of 0.85 or less was calculated and defined as the percentage of the irregular-shaped particles.

The number of the particles contained in the measurement sample increased as the particle diameter decreased. In all of the production examples and the comparative production examples, the number of the contained particles was within a range of from 1000 to 3000.

### (Measurement Conditions)

Thickness of the spacer of a flow cell: 50 μm
Telecentric zoom lens magnification: 4.5×
Total magnification: 9.0×
Measured amount: 0.5 mL
Image resolution: 0.185 μm/pixel
Detection algorithm: Ghost detection
Threshold: 15%

### 4. Residual Volatile Component Content

The amount of the residual volatile component contained in the particles (the residual volatile component content) was obtained by the following purge and trap gas chromatography (P&T/GC).

First, 0.1 g of the particles were put in a purge container. While flowing helium gas at a flow rate of 50 ml/min as a carrier gas, the purge container was started to be heated at a rate of 10° C./min from room temperature and kept at 200° C. for 30 minutes. A volatile component thus produced was collected into a trap tube at −130° C. The collected residual volatile component was quantified to obtain the residual volatile component content (the amount of the residual volatile component contained in the particles).

As a measurement device, GAS CHROMATOGRAPH 6890 (FID) manufactured by Agilent Technologies was used. As an analysis device, C-R7A CHROMATOPAC (manufactured by Shimadzu Corporation) was used. As a purge & trap sampler, TDS manufactured by Agilent Technologies was used. As a column, DB-5 manufactured by J&W (L=30 m, I.D.=0.32 mm, Film=0.25 μm) was used. Using them, the residual volatile component content was measured in the following conditions.
Column temperature: 50° C. (kept for two minutes) to 270° C. (increased at 10° C./min)
Sample feeding temperature: 280° C.
Detection temperature: 280° C.
Carrier gas: Helium gas, Flow rate: 1 ml/min

### 5. Particle Diameter and Particle Size Distribution

The particle diameter of the particles was measured by use of a particle size distribution measuring device by the Coulter counter method (product name: MULTISIZER 4e, manufactured by Beckman Coulter, Inc.) Then, the number average and the volume average were calculated therefrom to obtain the number average particle diameter (Dp) and the volume average particle diameter (Dv). By dividing the volume average particle diameter by the number average particle diameter, the particle size distribution (Dv/Dp) of the particles was obtained.

The measurement conditions were as follows.
Aperture diameter: 50 μm
Dispersion medium: ISOTON II (product name)
Concentration: 10%
Number of the measured particles: 100,000 particles

More specifically, 0.2 g of the sample particles were put in a beaker. As a dispersant, a surfactant aqueous solution (product name: DRIWEL, manufactured by Fujifilm Corporation) was added thereto. In addition, 2 mL of the dispersion medium was added to wet the particles. Then, 10 mL of the dispersion medium was added thereto. The mixture was dispersed for one minute with an ultrasonic disperser. Then, the measurement with the above-described particle size measuring device was carried out.

### 6. Void Ratio

### 6-1. Measurement of Apparent Density of Hollow Particles

First, approximately 30 cm³ of the hollow particles were introduced into a measuring flask with a volume of 100 cm³, and the mass of the introduced hollow particles was precisely weighed. Next, the measuring flask in which the hollow particles were introduced, was precisely filled with isopropanol up to the marked line while care was taken so that air bubbles did not get in. The mass of the isopropanol added to the measuring flask was precisely weighed, and the apparent density D₁ (g/cm³) of the hollow particles was calculated by the following formula (I).

$$Apparent density {D}_{1} = [ Mass of the hollow particles ] / ( 100 - [ Mass of the isopropanol ] / [ Specific gravity of the isopropanol at the measuring temperature ] ) \qquad Formula ( I )$$

### 6-2. Measurement of the True Density of the Hollow Particles

The hollow particles were pulverized in advance; approximately 10 g of the pulverized hollow particles were introduced into a measuring flask with a volume of 100 cm³; and the mass of the introduced pulverized particles were precisely weighed.

Then, similarly to the measurement of the apparent density mentioned above, isopropanol was added to the measuring flask; the mass of the isopropanol was precisely weighed; and the true density D₀ (g/cm³) of the hollow particles was calculated by the following formula (II).

$$True density {D}_{0} = [ Mass of the pulverized hollow particles ] / ( 100 - [ Mass of the ispropanol ] / [ Specific gravity of the isopropanol at the measuring temperature ] ) \qquad Formula ( II )$$

### 6-3. Calculation of Void Ratio

The void ratio of the hollow particles was calculated by the following formula (III), using the apparent density D₁ and the true density D₀.

$$Void ratio ( \% ) = 100 - ( Apparent density {D}_{1} / True density {D}_{0} ) \times 100 \qquad Formula ( III )$$

TABLE 1

| | | | Production | Production | Production | Production |
|---|---|---|---|---|---|---|
| | | | Example 1 | Example 2 | Example 3 | Example 4 |
| | | | Hollow | Hollow | Hollow | Hollow |
| | | | particles A | particles B | particles C | particles D |
| Polymerizable | Crosslinkable | Ethylene glycol dimethacrylate (parts) | 25 | 15 | 25 | 45 |
| monomer | acrylic monomer | Trimethylolpropane trimethacrylate (parts) | 30 | 20 | 30 | 45 |
| | Crosslinkable | Divinylbenzene (parts) | 45 | 65 | 45 | 10 |
| | hydrocarbon | | | | | |
| | monomer | | | | | |

| | | | | | |
|---|---|---|---|---|---|
| Polymerization initiator | 2,2′-Azobis(2,4-dimethylvaleronitrile) (parts) | 3 | 3 | 3 | 3 |
| Hydrophobic solvent | Hexane (parts) | 160 | 160 | 160 | 160 |
| Production condition | Rotational frequency (rpm) of disperser | 4000 | 4000 | 400 | 4000 |
| Physical properties | Iodine value (g/100 g) | 32 | 48 | 32 | 13 |
| of particles | Percentage (%) of particles having one hollow | More | More | More | More |
| | portion | 95 than | than 95 | than 95 | than 95 |
| | Percentage (%) of irregular-shaped particles | 5 | 7 | Less than 1 | 5 |
| | Residual volatile component content (ppm) | 10 | 28 | 5 | 10 |
| | Dv (μm) | 10 | 10 | 47 | 10 |
| | Particle size distribution (Dv/Dp) | 1.10 | 1.20 | 1.25 | 1.20 |
| | Void ratio (%) | 75 | 78 | 70 | 74 |

| | | | Comparative | Comparative | |
|---|---|---|---|---|---|
| | | | Production | Production | |
| | | | Example 1 | Example 2 | — |
| | | | Hollow | Solid | Carbon |
| | | | particles E | particles A | particles |
| Polymerizable | Crosslinkable | Ethylene glycol dimethacrylate (parts) | | 25 | |
| monomer | acrylic monomer | Trimethylolpropane trimethacrylate (parts) | | 30 | |
| | Crosslinkable | Divinylbenzene (parts) | 100 | 45 | |
| | hydrocarbon | | | | |
| | monomer | | | | |

| | | | | |
|---|---|---|---|---|
| Polymerization initiator | 2,2′-Azobis(2,4-dimethylvaleronitrile) (parts) | 3 | 3 | |
| Hydrophobic solvent | Hexane (parts) | 160 | 160 | |
| Production condition | Rotational frequency (rpm) of disperser | 4000 | 10 | |
| Physical properties | Iodine value (g/100 g) | 82 | 30 | 6.4 |
| of particles | Percentage (%) of particles having one hollow | More | Less | — |
| | portion | than 95 | than 5 | |
| | Percentage (%) of irregular-shaped particles | 5 | 5 | — |
| | Residual volatile component content (ppm) | 10 | 10 | — |
| | Dv (μm) | 10 | 10 | 0.038 |
| | Particle size distribution (Dv/Dp) | 1.20 | 1.10 | — |
| | Void ratio (%) | 80 | Less | — |
| | | | than 5 | |

### [Elastomer Composition Production and Elastomer Crosslinked Molded Body Production]

### Example 1

As the base material elastomer, 100 parts by mass of an ethylene-propylene-dien terpolymer (EPDM) (product name: NORDEL IP 4725, manufactured by: Dow Chemical Company, Mooney viscosity at 100° C. (JIS K6300): 25) was charged into a two-mixing roll kneader (model: DY6-15, manufactured by: Daihan, Co., Ltd., roll diameter: 6 inches, roll clearance: 0.5 mm) kept at a temperature of 80° C. The rotational frequency of the rotor of the kneader was set to 10 rpm to 35 rpm, and the base material elastomer was wound around the rolls. Then, 25 parts by mass of the hollow particles A obtained in Production Example 1 were charged into the kneader. Next, as a crosslinking agent, 3 parts of dicumyl peroxide (10-hour half-life temperature: 116° C., one minute half-life temperature: 175° C.) were charged into the kneader. Accordingly, a mixture was obtained. The obtained mixture was kneaded for 15 minutes, thereby obtaining the elastomer composition of Example 1.

The obtained elastomer composition was press-molded for 15 minutes by a hot press machine at 160° C. and a pressure of 10 MPa, thereby obtaining a columnar elastomer crosslinked molded body having a diameter of 29 mm±0.5 mm and a height of 12.5 mm±0.5 mm.

The obtained elastomer crosslinked molded body was used as a test piece in compression set measurement (JIS K 6262) described below.

### Examples 2 and 3

The elastomer composition and elastomer crosslinked molded body of Examples 2 and 3 were obtained in the same manner as Example 1, except that the amount of the added hollow particles A obtained in Production Example 1, was changed according to Table 2.

### Examples 4 to 6

The elastomer composition and elastomer crosslinked molded body of Examples 4 to 6 were obtained in the same manner as Example 1, except that according to Table 2, the hollow particles B obtained in Production Example 2, the hollow particles C obtained in Production Example 3 or the hollow particles D obtained in Production Example 4 were used instead of the hollow particles A obtained in Production Example 1.

### Examples 7 and 8

The elastomer composition and elastomer crosslinked molded body of Examples 7 and 8 were obtained in the same manner as Example 1, except that according to Table 2, NBR (acrylonitrile-butadiene rubber, product name: NIPOL (registered trademark) DN4050, manufactured by: ZEON Corporation, bound acrylonitrile amount: 40.0%, Mooney viscosity: 50.0) or HNBR (hydrogenated acrylonitrile-butadiene rubber, product name: ZETPOL (registered trademark) 2010L, manufactured by: ZEON Corporation, iodine value: 11.00 g/100 g, bound acrylonitrile amount: 36.2%, Mooney viscosity: 57.5) was used instead of the ethylene-propylene-dien terpolymer (EPDM).

### Comparative Example 1

The elastomer composition and elastomer crosslinked molded body of Comparative Example 1 were obtained in the same manner as Example 1, except that the hollow particles E obtained in Comparative Production Example 1 were used instead of the hollow particles A obtained in Production Example 1.

### Comparative Example 2

The elastomer composition and elastomer crosslinked molded body of Comparative Example 2 were obtained in the same manner as Example 1, except that the solid particle A obtained in Comparative Production Example 2 were used instead of the hollow particles A obtained in Production Example 1.

### Comparative Example 3

The elastomer composition and elastomer crosslinked molded body of Comparative Example 3 were obtained in the same manner as Example 1, except that 45 parts of carbon particles (product name: DIABLACK (registered trademark) H, manufactured by: Mitsubishi Chemical Corporation) were used instead of the hollow particles A (25 parts) obtained in Production Example 1.

### Reference Example 1

The elastomer composition and elastomer crosslinked molded body of Reference Example 1 were obtained in the same manner as Example 1, except that the hollow particles A obtained in Production Example 1 were not added.

### [Evaluation of Physical Properties of Elastomer Crosslinked Molded Body]

### 1. Weight Reduction Rate

The elastomer crosslinked molded body was cut into a 1 cm square piece (thickness 2 mm). Using the piece as a sample, the specific gravity of the elastomer crosslinked molded body was measured by the underwater replacement method in accordance with JIS K 7112:1999.

From the thus-measured specific gravity of the elastomer crosslinked molded body and the specific gravity of the base material elastomer used in the elastomer crosslinked molded body, the weight reduction rate (%) was calculated by the following formula (1).

$$Weight reduction rate ( \% ) = \{ ( Specific gravity of base material elastomer - Specific gravity of elastomer crosslinked molded body ) / Specific gravity of base material elastomer \} \times 100 \qquad Formula ( 1 )$$

The following values were used as the specific gravity of the base material elastomer.
Specific gravity of EPDM: 0.9
Specific gravity of NBR: 1.0
Specific gravity of HNBR: 1.0

### 2. Compression Set

The compression set (%) of the elastomer crosslinked molded body was measured by the room temperature test in accordance with JIS K 6262:2013, using the columnar elastomer crosslinked molded body having a diameter of 29 mm+0.5 mm and a height of 12.5 mm+0.5 mm as the test piece, in the following condition.
Standard temperature: 23° C.±2° C.
Testing temperature: 30° C.
Testing time: 168 hours
Test piece compression rate: 25%

The measurement result was evaluated based on the following evaluation criteria.

### (Compression Set Evaluation Criteria)

A: The compression set was less than 40%.
B: The compression set was 40% or more and less than 60%.
C: The compression set was 60% or more.

More specifically, the compression set was measured by the following steps. First, at the standard temperature, the thickness of the center of the test piece was measured. The test piece was placed d between compression plates (flat stainless-steel plates). A spacer (thickness 9.3 mm) was placed outside the test piece. They were compressed until the compression plates were firmly attached to the spacer. The apparatus compressing the test piece was kept in a constant temperature bath at the test temperature for the testing time mentioned above. After the lapse of the testing time, the apparatus was removed from the constant temperature bath. The test piece was immediately removed from the compression state, and it was left to stand for 30 minutes at the standard temperature. Then, the thickness of the center of the test piece was measured. From the thickness of the test piece before and after the compression and the thickness of the spacer, the compression set (%) was calculated by the formula (2).

$$\begin{matrix}[ Math . 1 ] & \\ CS = \frac{{t}_{0} - {t}_{2}}{{t}_{0} - {t}_{1}} \times 100 & Formula ( 2 )\end{matrix}$$

$$CS : Compression set ( \% )$$

$${t}_{0} : Original thickness ( mm ) of the test piece$$

$${t}_{1} : Thickness ( mm ) of the spacer$$

$${t}_{2} : Thickness ( mm ) of the test piece 30 minutes after being removed from the compression apparatus$$

TABLE 2

| | | | Example 1 | Example 2 | Example 3 | Example 4 | Example 5 | Example 6 | Example 7 |
|---|---|---|---|---|---|---|---|---|---|
| Elastomer | Base | Type | EPDM | EPDM | EPDM | EPDM | EPDM | EPDM | NBR |
| composition | material | Amount (parts) | 100 | 100 | 100 | 100 | 100 | 100 | 100 |
| | elastomer | | | | | | | | |
| | Particles | Hollow particles A | 25 | 15 | 10 | | | | 25 |
| | | (parts) | | | | | | | |
| | | Hollow particles B | | | | 25 | | | |
| | | (parts) | | | | | | | |
| | | Hollow particles C | | | | | 25 | | |
| | | (parts) | | | | | | | |
| | | Hollow particles D | | | | | | 25 | |
| | | (parts) | | | | | | | |
| | | Hollow particles E | | | | | | | |
| | | (parts) | | | | | | | |
| | | Solid particles A | | | | | | | |
| | | (parts) | | | | | | | |
| | | Carbon particles | | | | | | | |
| | | (parts) | | | | | | | |

| | | | | | | | | |
|---|---|---|---|---|---|---|---|---|
| Elastomer crosslinked | Specific gravity | 0.5 | 0.6 | 0.7 | 0.5 | 0.5 | 0.5 | 0.6 |
| molded body | Weight reduction | 44 | 33 | 22 | 44 | 44 | 44 | 40 |
| | rate (%) | | | | | | | |
| | Compression set | A | B | B | B | B | B | B |

| | | | | Comparative | Comparative | Comparative | Reference |
|---|---|---|---|---|---|---|---|
| | | | Example 8 | Example 1 | Example 2 | Example 3 | Example 1 |
| Elastomer | Base | Type | HNBR | EPDM | EPDM | EPDM | EPDM |
| composition | material | Amount (parts) | 100 | 100 | 100 | 100 | 100 |
| | elastomer | | | | | | |
| | Particles | Hollow particles A | 25 | | | | |
| | | (parts) | | | | | |
| | | Hollow particles B | | | | | |
| | | (parts) | | | | | |
| | | Hollow particles C | | | | | |
| | | (parts) | | | | | |
| | | Hollow particles D | | | | | |
| | | (parts) | | | | | |
| | | Hollow particles E | | 25 | | | |
| | | (parts) | | | | | |
| | | Solid particles A | | | 25 | | |
| | | (parts) | | | | | |
| | | Carbon particles | | | | 45 | |
| | | (parts) | | | | | |

| | | | | | | |
|---|---|---|---|---|---|---|
| Elastomer crosslinked | Specific gravity | 0.6 | 0.5 | 1.0 | 1.3 | 0.9 |
| molded body | Weight reduction | 40 | 44 | −11 | −44 | 0 |
| | rate (%) | | | | | |
| | Compression set | B | C | A | C | C |

### Consideration

The elastomer crosslinked molded bodies obtained in Examples 1 to 8 contained the hollow particles having an iodine value of 10 g/100 g or more and 50 g/100 g or less. Accordingly, compared to the elastomer crosslinked molded body of Reference Example 1 which was free of hollow particles, the weight of the elastomer crosslinked molded bodies was reduced, and the compression set thereof was small.

The reason why the compression set of Example 1 was smaller than Examples 2 and 3, is thought that the amount of the hollow particles contained in the elastomer crosslinked molded body of Example 1 was larger.

The reason why the compression set of Example 1 was small compared to Example 4 is estimated as follows: since the iodine value of the hollow particles was moderately small in Example 1, the aggregation of the hollow particles was suppressed, and the hollow particles were uniformly dispersed; moreover, since the residual volatile component content of the hollow particles was small in Example 1, good reactivity between the hollow particles and the base material elastomer was obtained and, as a result, the hollow particles uniformly suppressed the plastic deformation of the elastomer crosslinked molded body.

The reason why the compression set of Example 1 was small compared to Example 5 is estimated as follows: since the particle diameter of the hollow particles was moderately small in Example 1, the interface of the hollow particles and that of the base material elastomer increased, and much more crosslinks were formed between the hollow particles and the base material elastomer.

The reason why the compression set of Example 1 was smaller than Example 6 is estimated as follows: since the iodine value of the hollow particles was higher in Example 1, much more crosslinks were formed between the hollow particles and the base material elastomer.

The reason why the compression set of Example 1 was smaller than Examples 7 and 8 is estimated as follows: since the iodine value of the base material elastomer was higher in Example 1, much more crosslinks were formed between the hollow particles and the base material elastomer. Also, the compression set value of Example 7 was smaller than Example 8. The reason is estimated that the iodine value of the base material elastomer was higher in Example 7 than Example 8.

Meanwhile, the elastomer crosslinked molded body obtained in Comparative Example 1 contained the hollow particles having an iodine value of more than 50 g/100 g. Accordingly, the weight was reduced compared to the elastomer crosslinked molded body of Reference Example 1 which was free of hollow particles; however, the effect of reducing the compression set was poor compared to the elastomer crosslinked molded body obtained in Examples 1 to 8. The reason is estimated that the hollow particles used in Comparative Example 1 were likely to aggregate and were not uniformly dispersed in the elastomer crosslinked molded body.

The elastomer crosslinked molded body obtained in Comparative Example 2 contained the solid particles instead of hollow particles. Accordingly, the weight was not reduced compared to the elastomer crosslinked molded body of Reference Example 1 which was free of hollow particles. The reason for the small compression set of the elastomer crosslinked molded body obtained in Comparative Example 2 is estimated as follows: since the iodine value of the solid particles used in Comparative Example 2 was within a range of 10 g/100 g or more and 50 g/100 g or less, crosslinks were formed between the solid particles and the base material elastomer.

The elastomer crosslinked molded body obtained in Comparative Example 3 contained the carbon particles instead of hollow particles. Accordingly, the weight was not reduced compared to the elastomer crosslinked molded body of Reference Example 1 which was free of hollow particles, and the effect of reducing the compression set was poor compared to the elastomer crosslinked molded bodies obtained in Examples 1 to 8. The reason for the poor compression set reduction effect of the elastomer crosslinked molded body obtained in Comparative Example 3, is estimated as follows: since the iodine value of the carbon particles was less than 10 g/100 g, sufficient crosslinks were not formed between the carbon particles and the base material elastomer.

### REFERENCE SIGNS LIST

1. Aqueous medium
2. Low polarity material
4a. Hydrophobic solvent
4b. Material not containing hydrophobic solvent
6. Shell
7. Hollow portion
8. Droplet
9. Precursor particle
10. Hollow particle in which the hollow portion is filled with gas

1. Hollow particles comprising a shell, which contains a resin, and a hollow portion surrounded by the shell, wherein the hollow particles have an iodine value of 10 g/100 g or more and 50 g/100 g or less, which is measured in accordance with JIS K 0070.

2. The hollow particles according to claim 1, wherein a percentage of particles having a circularity of 0.85 or less is less than 15% by mass.

3. The hollow particles according to claim 1, wherein the hollow particles have a residual volatile component content of less than 100 ppm.

4. The hollow particles according to claim 1, wherein the hollow particles contain, as the resin, a polymer containing a crosslinkable monomer unit of 50% by mass or more.

5. The hollow particles according to claim 1, wherein the hollow particles have a volume average particle diameter of 0.1 μm or more and 100 μm or less.

6. An elastomer composition comprising the hollow particles defined by claim 1 and a base material elastomer.

7. The elastomer composition according to claim 6, wherein a content of the hollow particles is 10 parts by mass or more and 200 parts by mass or less with respect to 100 parts by mass of the base material elastomer.

8. An elastomer crosslinked molded body obtained by crosslinking molding the elastomer composition defined by claim 6.
